(19) United States
(12) Patent Application Publication
(10) Pub. No.: US 2025/0239268 A1
(43) Pub. Date: Jul. 24, 2025

(54) SOUND SOURCE EDIT FUNCTION PROVISION METHOD AND ELECTRONIC DEVICE SUPPORTING SAME

(71) Applicant: Samsung Electronics Co., Ltd., Suwon-si (KR)

(72) Inventors: Myungkyu CHOI, Suwon-si (KR); Seonghwan KIM, Suwon-si (KR); Hyunsoo KIM, Suwon-si (KR); Bongsoo JUNG, Suwon-si (KR)

(21) Appl. No.: 19/082,964

(22) Filed: Mar. 18, 2025

Related U.S. Application Data
(63) Continuation of application No. PCT/KR2023/012532, filed on Aug. 24, 2023.

(30) Foreign Application Priority Data
Oct. 7, 2022 (KR) 10-2022-0128645
Nov. 2, 2022 (KR) 10-2022-0144196

(51) Int. Cl. G10L 21/028; G06F 3/0482; G06F 3/0484

(52) U.S. Cl. CPC G10L 21/028; G06F 3/0482; G06F 3/0484

(57) ABSTRACT

A method of providing a sound source edit function performed by an electronic device, and the electronic device supporting the same, are provided. The method includes receiving an original sound source including a plurality of sound source elements, selecting a test sound source corresponding to the original sound source from among a plurality of test sound sources that are pre-stored, the multiple test sound sources each being matched to at least one of a plurality of sound source separators according to a performance indicator, selecting at least one sound source separator, which corresponds to separation of the test sound source, from among the plurality of sound source separators, extracting the plurality of sound source elements by separating the original sound source by using the selected at least one sound source separator, and storing an edited sound source including the extracted plurality of sound source elements.

### CROSS-REFERENCE TO RELATED APPLICATION(S)

This application is a continuation application, claiming priority under 35 U.S.C. § 365 (c), of an International application No. PCT/KR2023/012532, filed on Aug. 24, 2023, which is based on and claims the benefit of a Korean patent application number 10-2022-0128645, filed on Oct. 7, 2022, in the Korean Intellectual Property Office, and of a Korean patent application number 10-2022-0144196, filed on Nov. 2, 2022, in the Korean Intellectual Property Office, the disclosure of each of which is incorporated by reference herein in its entirety.

### BACKGROUND

### 1. Field

The disclosure relates to editing of a sound source.

### 2. Description of Related Art

As portable electronic devices become more widespread, functions are being provided to access various pieces of content through the portable electronic devices. Among them, a music output function, which stores sound source content or downloads and outputs sound source content from a specific server device, is a function favored by various users. Moreover, nowadays, while one-person or multi-person broadcasting channels are easily opened and shared, channels providing sound sources or channels providing music are rapidly increasing. The sound source may include various elements. For example, the sound source may include a human voice, the sound of a specific musical instrument, a specific sound effect, or the like.

In the meantime, there are differences in calls and non-calls of some of the various sound source elements included in the sound source for each user. For example, some users may wish to remove at least some of the sound source elements included in a specific sound source, or to modify some of the sound source elements. With regard to supporting these functions, a sound source separator is provided to separate sound source elements included in the specific sound source.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a sound source edit function provision method and an electronic device supporting the same.

Additional aspects will be set forth in part in the description which follows and, in part, will be apparent from the description, or may be learned by practice of the presented embodiments.

In accordance with an aspect of the disclosure, an electronic device is provided. The electronic device includes memory configured to store an original sound source and at least one instruction, and at least one processor operatively connected to the memory. The at least one instruction, when executed by at least one processor individually or collectively, causes the electronic device to receive an original sound source including a plurality of sound source elements, select a test sound source corresponding to the original sound source from among a plurality of pre-stored test sound sources that are pre-stored, the plurality of test sound sources each being matched to at least one of a plurality of sound source separators according to a performance indicator, select at least one sound source separator, which corresponds to separation of the test sound source, from among the plurality of sound source separators, extract the plurality of sound source elements by separating the original sound source by using the selected at least one sound source separator, and store an edit sound source including the extracted plurality of sound source elements.

In accordance with another aspect of the disclosure, a method of providing a sound source edit function performed by an electronic device is provided. The method includes receiving an original sound source including a plurality of sound source elements, selecting a test sound source corresponding to the original sound source from among a plurality of test sound sources that are pre-stored, the plurality of test sound sources each being matched to at least one of a plurality of sound source separators according to a performance indicator, selecting at least one sound source separator, which corresponds to separation of the test sound source, from among the plurality of sound source separators, extracting the plurality of sound source elements by separating the original sound source by using the selected at least one sound source separator, and storing an edit sound source including the extracted plurality of sound source elements.

In accordance with another aspect of the disclosure, a method for providing a sound source edit function (or a method for processing a sound source of content data) performed by an electronic device is provided. The method includes obtaining a sound source-separated edit sound source, providing a screen for selecting a sound field effect for at least one element among separated elements included in the edit sound source, receiving a user input for selecting a sound field effect, selecting a sound source separator optimized for a sound field effect selected by a user input among a plurality of sound source separators, and generating and storing a new edit sound source by separating an original sound source corresponding to the edit sound source by using the selected sound source separator.

At least one of operations described above may be performed by a server device or an electronic device. In this regard, an electronic device or a server device according to an embodiment of the disclosure may include at least one processor that operates the above-described method for providing a sound source edit function and memory supporting the same.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating an example of a system environment that supports a sound source separation function, according to an embodiment of the disclosure;

FIG. 2 is a block diagram illustrating an example of a configuration of an electronic device, according to an embodiment of the disclosure;

FIG. 3 is a diagram illustrating an example of a server device configuration, according to an embodiment of the disclosure;

FIG. 4 is a diagram illustrating an example of sound source separators, according to an embodiment of the disclosure;

FIG. 5 is a diagram illustrating an example of a method of operating a plurality of sound source separators, according to an embodiment of the disclosure;

FIG. 6 is a diagram illustrating an example of a method of operating a plurality of sound source separators, according to an embodiment of the disclosure;

FIG. 7 is a diagram showing an example of a metadata format according to sound source editing, according to an embodiment of the disclosure;

FIG. 8 is a diagram showing various examples of a metadata format according to sound source editing, according to an embodiment of the disclosure;

FIG. 9 is a diagram showing an example of sound source elements according to sound source editing, according to an embodiment of the disclosure;

FIG. 10 is a diagram illustrating an example of providing an object related to selecting a sound source element, according to an embodiment of the disclosure;

FIG. 11 is a diagram illustrating an example of a screen interface related to adjustment of a sound field effect of a single sound source element, according to an embodiment of the disclosure;

FIG. 12 is a diagram illustrating an example of a screen interface related to adjustment of a sound field effect of multiple sound source elements, according to an embodiment of the disclosure;

FIG. 13 is a diagram showing an example of a screen interface for applying a sound field effect for each sound source element, according to an embodiment of the disclosure;

FIG. 14 is a diagram showing an example of a screen interface related to a sound field effect, according to an embodiment of the disclosure; and

FIG. 15 is a block diagram of an electronic device 1501 in a network environment 1500, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, in the disclosure, it is possible to provide a method of selecting an optimal sound source separator and supporting the selected optimal sound source separator such that the selected optimal sound source separator is used to separate a sound source, when a plurality of sound source separators, which are specialized in editing (e.g., separation of sound source elements or separation of sound sources) specific sound source elements, are stored, and a request for sound source separation for an original sound source (or content) occurs. In this way, in the disclosure, it is possible to use various sound effects or sound field effects in duplicate, and to support the creation of a new edited sound source through mixed playback of each edited (or separated) sound source element, thereby improving user satisfaction in sound source separation and utilization operations.

Hereinafter, a system environment that selects and utilizes a sound source separator capable of separating a specific sound source by using a plurality of proposed sound source separators with the accuracy of a specified reference value or higher or separating a sound source with optimal performance, and each device that constitutes the system environment will be described in the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

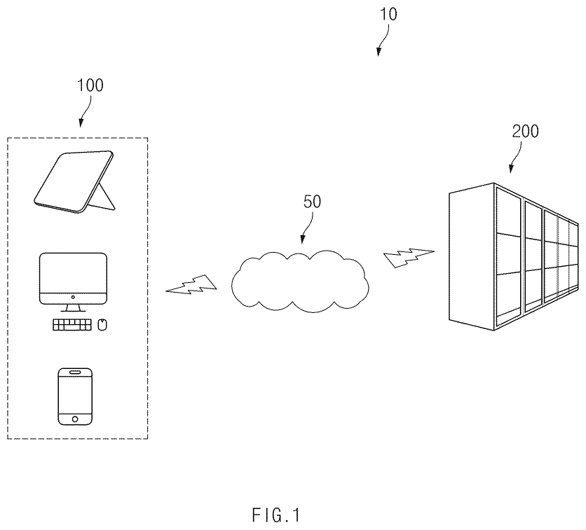

FIG. 1 is a diagram illustrating an example of a system environment that supports a sound source separation function, according to an embodiment of the disclosure.

Referring to FIG. 1, a system environment 10 supporting sound source separation according to an embodiment may include at least one electronic device 100 (or a user terminal, a portable terminal, or a portable electronic device), a network 50, and a server device 200 (e.g., a cloud server device).

The network 50 may establish a communication channel between the at least one electronic device 100 and the server device 200. The network 50 may include, for example, at least one of a wireless communication network element or a wired communication network element. According to an embodiment, the network 50 may include at least one of a mobile communication network including at least one base station, a base station controller and a core system, and an Internet network connected to the mobile communication network. When the at least one electronic device 100 includes a mobile terminal or a portable terminal, the network 50 may support the establishment of a communication channel of the portable terminal based on the mobile communication network. As described above, the network 50 is a component capable of transmitting and receiving signals or data by establishing a communication channel between the server device 200 and the at least one electronic device 100, and is not limited to a specific communication method or communication equipment.

The server device 200 may establish a communication channel with the at least one electronic device 100 through the network 50 and may support a sound source edit function at the request of the at least one electronic device 100. For example, the server device 200 may prepare the communication channel for access to the at least one electronic device 100. When the at least one electronic device 100 is connected, the server device 200 may provide the at least one electronic device 100 with a screen related to sound source separation. The server device 200 may receive an original sound source (or content) from the at least one electronic device 100, or may obtain (or receive) an original sound source, which is selected by a user of the electronic device 100, from among at least one pre-stored original sound source from an external electronic device or a server memory. The server device 200 may select a sound source separator that provides optimal sound source separation performance for the original sound source received or obtained from among a plurality of sound source separators. The server device 200 may separate the original sound source by using the selected sound source separator and may store or provide the result to the at least one electronic device 100. In the above-described operation, the server device 200 may select a test sound source corresponding to the original sound source among pre-stored test sound sources, and may select a sound source separator that provides optimal performance for the selected test sound source.

According to an embodiment, the server device 200 may provide the at least one electronic device 100 with a sound source list edited (or sound source elements are separated). When a specific edit sound source is selected by a user, and then a sound field effect (e.g., a type of an effect, sound source characteristics, or an application service, an application program, or a type of an application applied to the edit sound source such as editing) for the selected edit sound source element is selected, the server device 200 may select a sound source separator, which is capable of optimally providing the selected sound field effect, from among a plurality of sound source separators. The server device 200 may perform sound source separation on an original sound source by using the selected sound source separator, and may store the result in the server device 200 or provide the result to the at least one electronic device 100. For example, when an application program (or an application) related to applying a specific audio function (or sound field effect) to a finally-edited sound source is selected, the server device 200 may select a specific sound source separator corresponding to the type of the application program from among a plurality of sound source separators. The selected specific sound source separator may be a sound source separator capable of optimizing or improving the audio characteristics of the application program.

According to an embodiment, when an application program (or an application), in which the quality of user's voice information is important, such as speech recognition or a call function, is running, the server device 200 may select a sound source separator, which has the highest signal to noise ratio (SNR) for voice information, from among the sound source separators (or sound source separation engines).

According to an embodiment, when an application program (or an application) used in a situation where background noise (e.g., ambient noise such as a buzzing bubble noise or car noise) needs to be improved or minimized to emphasize a main sound source (e.g., music or voice) is running, the server device 200 may select a sound source separator, which has the highest background noise removal performance (or has the predefined performance or higher), from among the sound source separators.

According to an embodiment, when an application program (or an application), in which the quality of a specific sound source (e.g., a sound in a specific direction or a sound of a single instrument such as a piano) is important, is running, the server device 200 may select a sound source separator, which has the best performance in emphasizing the sound source in the specific direction, from among a plurality of sound source separators. As described above, the server device 200 may select a sound source separator, which is capable of optimizing the audio performance of an application program or application, depending on the characteristics of the application program (or the application) currently running on the electronic device 100. For example, the server device 200 may select a sound source separator, which is capable of optimizing or improving the corresponding performance, depending on the type of an application program, which is related to the specific audio performance or to which the specific audio function is applied.

According to an embodiment, when providing the electronic device 100 with an application list (or an application program list) related to the playback of the finally-edited sound source, or obtaining application information (or application program information) related to the playback of the sound source from the electronic device 100, the server device 200 may select an optimal sound source separator related to the finally-edited sound source selected in response to a user input from among a plurality of sound source separators. For example, when an application (or an application program) related to the finally-edit sound source playback is selected, the server device 200 may identify the audio characteristics emphasized in the corresponding application program, may select a sound source separator optimized for the identified audio characteristics, may create a new edit sound source by performing a sound source separator on the original sound source (or an edit sound source), and may provide the new edit sound source to the electronic device 100. The electronic device 100 may receive the new edited sound source optimized for an application (or an application program) to be executed and may play the new edited sound source based on the application (or the application program).

The at least one electronic device 100 may include an electronic device capable of accessing the server device 200 over the network 50. According to an embodiment, the at least one electronic device 100 may include a portable communication device or portable terminal that is capable of accessing the server device 200 over a mobile communication network. Alternatively, the at least one electronic device 100 may include a portable terminal that is connected to a wireless communication such as Wi-Fi to access the server device 200 over an Internet network. Alternatively, the at least one electronic device 100 may include a desktop computer, etc. As described above, the at least one electronic device 100 is an electronic device capable of accessing the server device 200 over the network 50, and is not limited to the shape, size, or number thereof. According to an embodiment, the at least one electronic device 100 may access the server device 200 based on address information of the server device 200 and may use a sound source edit function provided by the server device 200. In this operation, after the at least one electronic device 100 provides an original sound source (or content) to the server device 200, or selects at least one original sound source from among a plurality of original sound sources provided by the server device 200, the at least one electronic device 100 may request the server device 200 to separate a sound source from the corresponding original sound source. The at least one electronic device 100 may receive and output a sound source element, in which a sound source provided by the server device 200 is separated, or the edited sound source including the sound source element. Moreover, the at least one electronic device 100 may select at least one edited sound source provided by the server device 200 and may provide the server device 200 with a user input for adjusting a sound field effect for a specific sound source element included in the edited sound source. In response thereto, after the optimal sound source separator for applying a user selection sound field effect to the original sound source is selected by the server device 200, the original sound source corresponding to the edited sound source may be separated again by using the selected optimal sound source separator.

In the meantime, in the above description, it is described that the server device 200 stores a plurality of sound source separators, and the server device 200, which is a subject selecting the optimal (or providing performance of a specified level or higher) sound source separator depending on the characteristics of the original sound source, performs related operations, but the disclosure is not limited thereto. For example, at least one among the at least one electronic device 100 may include a plurality of sound source separators, and may perform an operation of selecting a sound source separator for sound source separation for an original sound source stored in the electronic device 100 or an original sound source received from an external electronic device. Furthermore, in response to a selection of a sound field effect for the edited sound source, the electronic device 100 including a plurality of sound source separators may select a sound source separator for optimally providing the corresponding sound field effect. Accordingly, the sound source separator selecting function of the disclosure may be provided through the server device 200, but may also be performed by the at least one electronic device 100 itself. The at least one electronic device 100 may receive and store a plurality of sound source separators capable of providing sound source separator selecting function from the server device 200. At least one sound source separator among the plurality of sound source separators may be composed of at least one of a processing module, a program, an application, or a trained deep learning model. According to an embodiment, in relation to the audio performance of an application program, which is currently running or which is selected by a user, the at least one electronic device 100 may select a sound source separator, which is capable of optimizing the corresponding audio function, from among a plurality of sound source separators. For example, the at least one electronic device 100 may select a sound source separator, which is capable of optimizing or improving the corresponding performance, depending on the type of an application program, to which the specific audio function is applied.

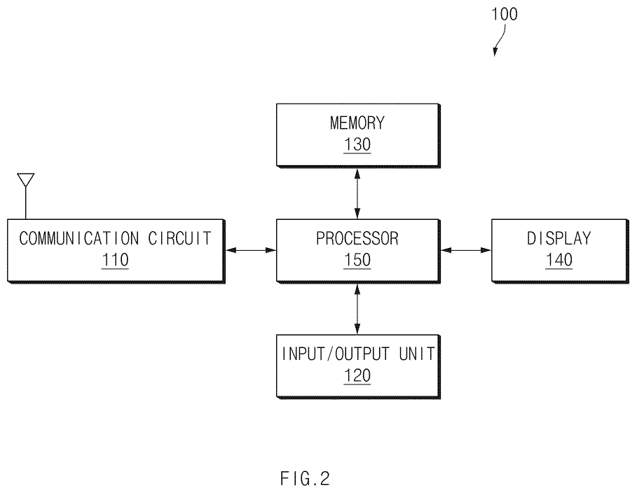

FIG. 2 is a block diagram illustrating an example of a configuration of an electronic device, according to an embodiment of the disclosure.

Before the descriptions, the electronic device configuration described in FIG. 2 may be one of the at least one electronic device 100 described in FIG. 1. Accordingly, the electronic device will be described below by assigning the drawing number 100.

Referring to FIG. 2, the electronic device 100 according to one embodiment may include a communication circuit 110, an input/output unit 120, memory 130, a display 140, and a processor 150.

The communication circuit 110 may establish at least one communication channel in relation to supporting the communication function of the electronic device 100. For example, the communication circuit 110 may establish a communication channel with the server device 200 over the network 50. The communication circuit 110 may support at least one communication method among various communication methods such as 3G, 4G, LTE, or 5G. The communication circuit 110 may include a plurality of communication modules so as to support a plurality of communication methods. According to an embodiment, the communication circuit 110 may transmit an original sound source to the server device 200 under the control of the processor 150 or may transmit a user input for selecting a specific original sound source stored in the server device 200 to the server device 200. The communication circuit 110 may receive the edited sound source created by applying a sound source separating function to a specific original sound source under the control of the processor 150.

The input/output unit 120 may include at least one input means supporting the input function of the electronic device 100, and at least one output means supporting the output function of the electronic device 100. According to an embodiment, the input means may include various means such as, for example, a touchpad, a touch key, a physical key, a physical button, a voice input device, a jog shuttle, or a joystick. According to an embodiment, when the display 140 includes a touchscreen supporting a touch function, the display 140 may be included in the input means. The output means may include a speaker that outputs an audio signal according to sound source playback, a vibration module that outputs vibration of a specific pattern, and an LED lamp that outputs light of a specific color. According to an embodiment, the speakers included in the output means may output at least some sound source elements of the edited sound source.

The memory 130 may store various pieces of data or programs necessary for operating the electronic device 100. According to an embodiment, the memory 130 may store a browser program related to the access to the server device 200 or an application supporting the access to the server device 200. The memory 130 may store at least one original sound source to be transmitted to the server device 200. According to an embodiment, the memory 130 may store at least one edited sound source received from the server device 200. When the electronic device 100 is designed to support a function of selecting an optimal sound source separator among a plurality of sound source separators, the memory 130 may store the plurality of sound source separators that support the sound source separating function for an original sound source, and a plurality of test sound sources.

The display 140 may provide various screens according to the operation of the electronic device 100. For example, the display 140 may output an access screen according to the access to the server device 200, a screen for transmitting the original sound source to the server device 200, a screen for selecting the optimal sound source separator corresponding to the transmitted original sound source, a screen for editing the original sound source by the selected sound source separator, a screen for creating the edited sound source, or a screen for downloading the edited sound source When the electronic device 100 directly includes a plurality of sound source separators and provides a sound source separator selecting function, the display 140 may output a screen for selecting a sound source separator corresponding to the original sound source among a plurality of sound source separators. According to an embodiment, the display 140 may output at least one of a first screen for selecting at least one edited sound source, a second screen for adjusting a sound field effect of a specific sound source element among edited sound sources, or a third screen for selecting a new sound source separator depending on a sound field effect control request. When the sound source separator selecting function is provided by the server device 200, the at least one of the first to third screens may be provided by the server device 200. When the sound source separator selecting function is provided by the electronic device 100, the at least one screen among the first to third screens may be generated and provided under the control the processor 150 of the electronic device 100.

The processor 150 may control the transmission, processing, and storage of a signal according to the operation of the electronic device 100. For example, the processor 150 may control the access to the server device 200 in response to a user input, and may control the display 140 to output a screen related to the sound source separator selecting function provided by the server device 200. Under the control of the processor 150, the original sound source stored in the memory 130 may be transmitted to the server device 200 in response to a user input in a screen output state related to sound source separator selection Alternatively, the processor 150 may provide a screen for selecting at least one original sound source stored on the server device 200, and user selection information may be transmitted to the server device 200 under the control of the processor 150. The processor 150 may receive the edited sound source for an original sound source selected by a user from the server device 200. Under the control of the processor 150, the received edited sound source may be stored in the memory 130 in response to a user input.

According to an embodiment, under the control of the processor 150, a screen for selecting at least one edit sound source stored in the server device 200 may be output to the display 140, and a screen including a plurality of sound source elements included in the edit sound source selected in response to a user input may be output to the display 140. The processor 150 may transmit a message for requesting a change in sound field effect for a specific sound source element to the server device 200 in response to a user input and may receive a new edit sound source including a sound source element having the changed sound field effect from the server device 200. The received new edit sound source may be stored in the memory 130 in response to a user input.

According to an embodiment, the electronic device 100 may provide the sound source separator selecting function directly without interlocking with the server device 200. In this case, the processor 150 may receive an original sound source from an external electronic device through the communication circuit 110 or may collect the original sound source by using a microphone. When the original sound source is collected, the processor 150 may select the corresponding test sound source and may select a pre-evaluated sound source separator so as to provide optimal performance for the test sound source. The processor 150 may perform sound source separation on the original sound source by using the selected sound source separator and may output the edited sound source or store the edited sound source in the memory 130. According to an embodiment, when at least one edit sound source stored in the memory 130 is selected in response to a user input, a screen interface for adjusting the sound field effect of sound source elements included in the selected edit sound source may be output under the control of the processor 150. When the sound field effect is adjusted in response to a user input, the processor 150 may select a sound source separator capable of providing optimal performance for the adjusted sound field effect, and a new edit sound source may be created by performing sound source separation on the original sound source corresponding to the edit sound source by using the selected sound source separator under the control of the processor 150.

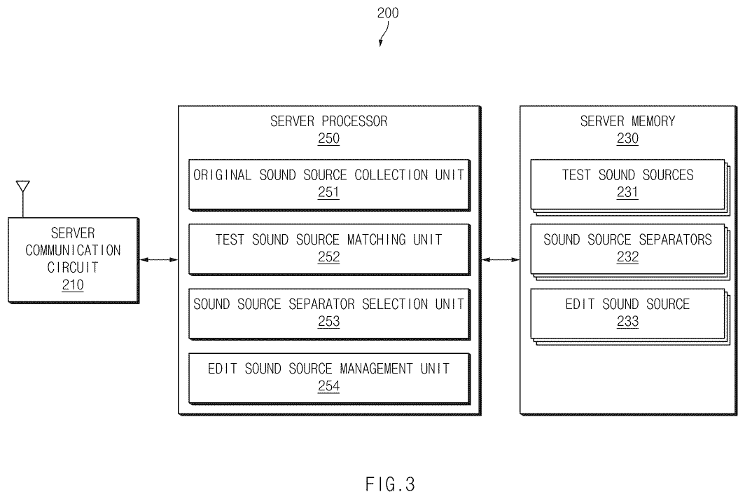

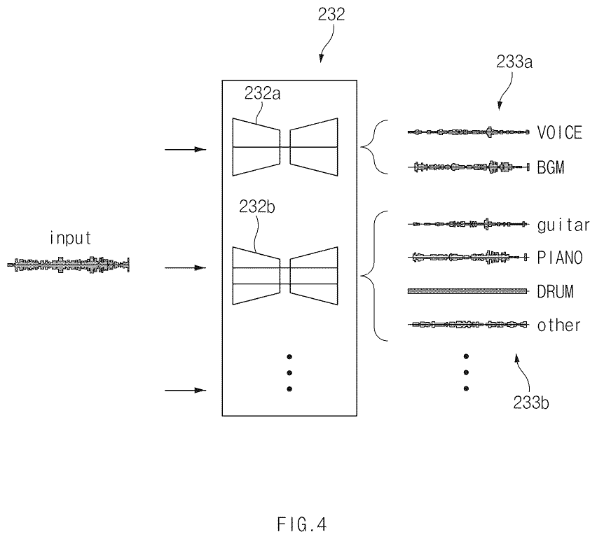

FIG. 3 is a diagram illustrating an example of a server device configuration, according to an embodiment of the disclosure. FIG. 4 is a diagram illustrating an example of sound source separators, according to an embodiment of the disclosure. The configuration of the server device described in FIG. 3 may be an example of the configuration of the server device described in FIG. 1.

Referring to FIG. 3, the server device 200 according to an embodiment may include a server communication circuit 210, a server memory 230, and a server processor 250.

The server communication circuit 210 may support a communication function of the server device 200. The server communication circuit 210 may establish a communication channel with the at least one electronic device 100 over the network 50. According to an embodiment, the server communication circuit 210 may provide a screen corresponding to a sound source separator selecting function to the at least one electronic device 100, and may receive an original sound source from the at least one electronic device 100 or receive a user input for selecting an original sound source stored in the server memory 230. The server communication circuit 210 may transmit an edited sound source to the at least one electronic device 100 at the request of the at least one electronic device 100.

The server memory 230 may store data or programs necessary for operating the server device 200. According to an embodiment, the server memory 230 may store a test sound sources 231 (or test vector sound sources), sound source separators 232, and an edit sound source 233 in relation to supporting a sound source separator selecting function.

The test sound sources 231 may include test vector values for various sound sources. The test vector included in the test sound sources 231 may be composed of basic information, mixed-data of sound, and sound source (source) for each channel. The test sound sources 231 may be matched to the plurality of sound source separators 232, respectively. At least one specific sound source separator among the plurality of sound source separators 232 may provide optimal performance with respect to a specific test sound source included in the plurality of test sound sources 231. According to an embodiment, the test sound sources 231 may include sound sources in which a plurality of sound source elements (e.g., at least some sound source elements of voices, specific musical instruments, and sounds in a specific frequency band) are defined differently. For example, the test sound sources 231 may include a test sound source matching a sound source separator having optimal performance for sound source separation of voices, a test sound source matching a sound source separator having optimal performance for sound source separation of a specific type of musical instrument sound source element, and a test sound source matching a sound source separator having optimal performance for sound source separation of sounds in a specific frequency band. The test sound sources 231 described above may be stored in advance, and each of the test sound sources 231 may include matching information with an optimal sound source separator. According to an embodiment, at least one of processing amounts to be allocated and/or memory allocation amounts may be different for the respective test sound sources 231.

The sound source separators 232 may include a plurality of sound source separators capable of separating at least one sound source element from an original sound source including at least one sound source element. Referring to FIG. 4, as illustrated in drawings, the sound source separators 232 may include a first sound source separator 232a and a second sound source separator 232b. The sound source separators 232 may perform sound source separation on the original sound source (input) (e.g., an input sound source or an input) under the control of the processor 150. The sound source separators 232 may have different numbers of sound source elements capable of being separated depending on their performance. Alternatively, the sound source separators 232 may have different distortion levels of the separated sound source elements depending on the performance thereof. According to an embodiment, the first sound source separator 232a among the sound source separators 232 may separate two first sound source element groups 233a (e.g., voices or background music (BGM)) from the original sound source (input). The second sound source separator 232b among the plurality of sound source separators 232 may extract four second sound source element groups 233b (e.g., a guitar, a piano, drums, or others) from the original sound source (input). According to an embodiment, the second sound source separator 232b may separate at least some sound source elements (e.g., voices or BGM) of the first sound source element group 233a separated by the first sound source separator 232a. The performance of sound source separation may vary depending on the performance of a sound source separator itself or hardware allocation amounts for operating the sound source separator.

Each of the sound source separators 232 may be matched to at least one test sound source. For example, the sound source separators 232 may include commercial sound source separators. For example, each of the sound source separators 232 may have a characteristic that the sound source separation performance for a specific sound source element is superior to the sound source separation performance for other sound source elements. Here, for example, the sound source separation performance may be identified depending on the distortion of the original sound source characteristics of a specific sound source element. For example, the sound source separators 232 include three sound source separators. One sound source separator, which has the lowest distortion when a voice is separated from the original sound source including the voice, from among the three sound source separators may be distinguished as the sound source separator having higher performance than the other sound source separators. According to an embodiment, at least some of the sound source separators 232 may have different memory allocation amounts and CPU amounts to be allocated at runtime. Alternatively, at least some of the sound source separators 232 may have different amounts of bandwidth that need to be allocated at runtime.

The edit sound source 233 may be information, which is stored after a specific sound source separator is selected from the sound source separators 232 and the original sound source is edited by the selected sound source separator. The edit sound source 233 may include at least some of an original sound source, information about sound source elements separated from the original sound source, type information about a sound source separator used during editing, or type information about a sound field effect (e.g., an effect type, sound source characteristics, or an application service, an application program or an application such as editing). At the request of the electronic device 100, the edit sound source 233 may be updated such that the edit sound source 233 is changed to a new edit sound source. The edit sound source 233 may store an address value, at which the original sound source is stored, without including the original sound source separately or may store the address value at which separated sound source elements are stored.

According to an embodiment, the server memory 230 stores a plurality of sound field effectors (or effect modules) and may provide a sound field effector list capable of being provided by the server device 200 at the request of the electronic device 100.

The server processor 250 may control the transmission and processing of signals for the operation of the server device 200 and the storage of the processed results. According to an embodiment, the server processor 250 may include an original sound source collection unit 251, a test sound source matching unit 252, a sound source separator selection unit 253, and an edit sound source management unit 254 in relation to supporting a sound source separator selecting function according to an embodiment.

The original sound source collection unit 251 may process original sound source collection. For example, when the electronic device 100 is connected, the original sound source collection unit 251 may assign a channel capable of providing or registering the original sound source, from which a sound source is separated. In this operation, the original sound source collection unit 251 may provide the electronic device 100 with an access screen including items related to original sound source registration. According to an embodiment, the original sound source collection unit 251 may collect the original sound source by accessing an external server device that provides the original sound source depending on a specified period. Alternatively, when receiving an update message for a specific original sound source from a specified external server device, the original sound source collection unit 251 may receive the original sound source from the external server device and may store the original sound source in the server memory 230.

The test sound source matching unit 252 may compare features of the original sound source, from which a sound source is requested to be separated, with features of test sound sources. For example, the test sound source matching unit 252 may extract a representative feature of the original sound source and may detect the test sound source (or a test vector) that is most similar to the representative feature (or has a similarity of a reference value or higher). According to an embodiment, the test sound source matching unit 252 may extract sound information (e.g., at least one of the genre of the original sound source, the number and types of musical instruments used in the original sound source, or the sound field effect applied to the original sound source) of an original sound source and may detect a test sound source having sound information identical or similar to the sound information. In this regard, at least some of the test sound sources 231 may include sound information capable of being compared to sound information stored in the original sound source. When a test sound source corresponding to the original sound source is detected, the test sound source matching unit 252 may deliver the detected test sound source to the sound source separator selection unit 253. According to an embodiment, the test sound source matching unit 252 may select the test sound source, by using classification information (e.g., ID3) registered in a file tag of the original sound source or by evaluating the similarity between a sound and the prepared test sound sources 231 (or a test vector set).

The sound source separator selection unit 253 may receive the test sound source from the test sound source matching unit 252 and may select a sound source separator matching the received test sound source from the plurality of sound source separators 232. In this regard, each or at least some of the plurality of sound source separators 232 stored in the server memory 230 may include information matching the test sound sources 231. Alternatively, the server memory 230 may store a matching table that matches the test sound sources 231 with the sound source separators 232. According to an embodiment, the sound source separator selection unit 253 may transmit the test sound source to a specified external server device having various sound source separators, and may also receive a sound source separator in software form (e.g., in a form of an application or a processing module) corresponding to the test sound source from the specified external server device.

According to an embodiment, the sound source separator selection unit 253 may identify the resource utilization status of the server device 200 (or an external server device) that will perform processing on the original sound source together with the test sound source. For example, the resource utilization status of the server device 200 (or the external server device) may include hardware resources (e.g., remaining memory capacity, remaining CPU capacity, and remaining power) of the server device 200 (or the external server device) and network resources (e.g., network data transmission speed and network delay time). The sound source separator selection unit 253 may determine whether the time required to separate a specific sound source is within a predefined reference value, and may select a sound source separator that separates a specific sound source within the reference value. When the sound source separator is on an external server device, the time required to download a sound source separator stored in the external server device and to separate the sound source by using the downloaded sound source separator, or the time required to separate a sound source by using a sound source separator stored in the external server device may be calculated, and a sound source separator whose calculated value is within the specified value may be selected. According to an embodiment, the sound source separator selection unit 253 may extract at least one sound source separator candidate group capable of being used based on the test sound source, and may select a sound source separator (or a sound source separator that provides the most optimal processing speed and processing time) that satisfies a specified processing speed or processing time among the sound source separator candidate group.

According to an embodiment, the sound source separator selection unit 253 may generate data for scoring the plurality of sound source separators 232 stored in the server memory 230 (or stored in the external server device). For example, the sound source separator selection unit 253 may calculate scores for a quality item (eval: SNR, SDR, SIR and similarity after sound effect by test) corresponding to quality performance quantitative values from the separated sound source results, a time (inference) item corresponding to the execution speed when a sound source is separated, a size (memory) item corresponding to the memory size used when a sound source is separated, and a system (capa) item (e.g., at least one of a central processing unit (CPU), a graphic processing unit (GPU), a neural processing unit (NPU) and/or a network element) corresponding to the performance indicator in a system. After calculating the final score of the calculated scores based on Equation 1, the sound source separator selection unit 253 may select a sound source separator to be used for sound source separation for the original sound source or sound field effect for the edit sound source based on the final score.

$$score = α \times quality ( eval ) + β \times time ( inference ) + γ \times size ( memory ) + δ \times system ( capa ) \qquad Equation 1$$

In Equation 1, α, β, γ, and δ may be weight values, and may be constant values determined by a specified condition.

According to an embodiment, in relation to the system item, the sound source separator selection unit 253 may identify the current system status. For example, when a system is composed of a single processor, the sound source separator selection unit 253 may identify at least one of resources (e.g., at least one of the capacity of memory, a CPU, a GPU, a DSP, or an NPU), speed, and current consumption. When the system is composed of distributed processors, the sound source separator selection unit 253 may identify at least one of a system status (e.g., memory, speed, and current consumption) of the external processor, the status and delay time of a network, or the capability check result of the external processor. Moreover, the sound source separator selection unit 253 may select a sound source separator based on the checked result. The above-described operation may be identified at a point in time when the sound source separator is stored in the server memory 230 or at a point in time when an operation for selecting the sound source separator of an external server device is performed.

According to an embodiment, in relation to calculating the performance indicator of the sound source separator, the sound source separator selection unit 253 may obtain the sound source separation results according to applying each of the sound source separators 232 to the test sound sources 231. In addition, the sound source separator selection unit 253 may determine a primary state element in the single or distributed system to be used for the sound source separators by updating pieces of content of the system item for each sound source separator. For example, the sound source separator performance indicator may include at least one of SDR, SAR, SIR, SNR or similarity after a sound field effect is applied.

According to an embodiment, the SDR may be the distortion of the separated sound source or the distortion of the separated sound source to the original sound source (source) of the test sound source (or a test vector), and may be obtained based on Equation 2 below.

$$SDR = 10 {log}_{10} \frac{{\sum }_{n} {‖ s ( n ) ‖}^{2} + ϵ}{{\sum }_{n} {‖ s ( n ) - \hat{s} ( n ) ‖}^{2} + ϵ} , \qquad Equation 2$$

The above-described SDR may indicate the degree of closeness to the intended sound source, and may indicate that the quality of the separated sound source (channel) is good, as the result value is great. In Equation 2, ‘s’ may denote a correct signal (ground truth); ŝ may denote the sound source (estimate) obtained from a sound source separator; and, ‘ε’ may denote any very small value for preventing the equation from becoming zero.

According to an embodiment, the SAR may indicate the sound source separation performance caused by the self-defect of the separated sound source and may be obtained based on Equation 3 below.

$$SAR := 10 {log}_{10} \frac{{‖ {s}_{target} ‖}^{2}}{{‖ {e}_{artif} ‖}^{2}} \qquad Equation 3$$

In Equation 3, S_target may denote a correct signal, and e_artif may denote a noise value caused by a defect in the sound source separator itself. The SAR may indicate the degree of sound distortion of a separate sound source (channel) itself.

According to an embodiment, the SIR may indicate the sound source separation performance due to the influence of the next sound sources, and may be obtained based on Equation 4 below.

$$SIR := 10 {log}_{10} ( \frac{{‖ {s}_{target} ‖}^{2}}{{‖ {e}_{interf} ‖}^{2}} ) \qquad Equation 4$$

In Equation 4, S_target may denote a correct signal, and e_interf may denote the noise value due to the influence of other channels. The SIR may indicate the influence of other signals remaining in a separate sound source (channel).

According to an embodiment, the SNR may indicate all noise effects related to sound source separation and may be obtained based on Equation 5 below.

$$SNR := 10 {log}_{10} ( \frac{{‖ {s}_{target} ‖}^{2}}{{‖ {s}_{target} - \hat{s} ‖}^{2}} ) \qquad Equation 5$$

In mathematical expression 5, S_target may denote the correct signal, and may denote the sound source (estimate) obtained from the sound source separator.

According to an embodiment, after an effect (a sound field effect) is applied, the result similarity may be calculated based on Equation 6 below.

$$similarity ( effect ( {S}_{target} ) , effect ( \hat{S} ) ) \qquad Equation 6$$

In Equation 6, S_target may denote a correct signal; $ may denote a sound source (estimate) obtained from a sound source separator; effect ( ) may denote an effect application function; and, similarity ( ) may denote a similarity calculation function.

The above-described sound source separation performance indicator may be used to standardize the performance of the plurality of sound source separators 232, and the sound source separator selection unit 253 may adopt and use at least one of the various performance indicator items described above. According to an embodiment, in relation to the performance of sound source separation, the sound source separator selection unit 253 may select a sound source separator in consideration of a system load (e.g., memory, a computational amount, or delay time) and the distortion of the separated sound source. Alternatively, the sound source separator selection unit 253 may select a sound source separator that has a higher SNR for voices by better identifying the voices, or a sound source separator for better performance on sound sources with specific harmonics such as a specific musical instrument or sound source type so as to match the original sound source. Alternatively, the sound source separator selection unit 253 may select a sound source separator having higher performance in a sound field effect application operation.

When the original sound source is separated by using the sound source separator selected by the sound source separator selection unit 253, the edit sound source management unit 254 may generate parameter information about the separated original sound source, and may store the edited sound source together with the generated parameter information in the server memory 230. For example, the parameter information may include at least one of the number of sound source elements separated from the original sound source, the type of a sound source elements separated, the type of a sound source separator used to separate an original sound source, or the time required to separate a sound source. The edit sound source management unit 254 may store and manage original sound source information corresponding to the edit sound source 233. The edit sound source management unit 254 may provide an edit sound source including parameter information to the electronic device 100 from which the separation of the original sound source is requested. Alternatively, the edit sound source management unit 254 may provide the electronic device 100 with a list of the at least one edit sound source 233 stored in the server memory 230, and may provide the electronic device 100 with the edit sound source according to user selection.

The edit sound source management unit 254 may receive, from the electronic device 100, a message for requesting a change in a sound field effect for a specific sound source element included in the edit sound source. In this case, the edit sound source management unit 254 may deliver, to the sound source separator selection unit 253, a message for requesting a change in the sound field effect and the original sound source corresponding to the edit sound source.

The sound source separator selection unit 253 may select an optimal sound source separator to change the sound field effect of a specific sound source element included in the original sound source. In this regard, the server memory 230 may store and manage a list of optimal sound source separators depending on changes in the sound field effect of the sound source element. The sound source separator selection unit 253 may identify the sound source separator list (e.g., at least one of identification information (e.g., the name or designation number of a sound source separator) of a sound source separator, storage location of the sound source separator, characteristics of the sound source separator (e.g., descriptions of the type of a sound source having the better performance), and sound source separator preference (including preference corresponding to choices of various users and preferred sound source information of the users) stored in the server memory 230, may select a sound source separator optimized for the original sound source, from which a user makes a request for separating a sound source and to which the user makes a request for applying a sound field effect, may re-perform sound source separation on the original sound source by using the selected sound source separator, and may create a new edit sound source by applying the sound field effect to the sound source element specified by the user among the sound source elements according to the re-performing of the sound source separation. The edit sound source management unit 254 may process updating parameter information about the new edit sound source.

According to an embodiment, the sound source separator selecting function may be performed in, for example, the electronic device 100. In this case, the above-described operation of the server processor 250 may correspond to the operation of the processor 150 of the electronic device 100. According to an embodiment, at least one of at least one sound source separator, an original sound source, a test sound source (or a test vector), an effect module (or a sound field effector), or a computing device for selecting a sound source separator may be in an external network and may be used as a system (capa) element for selecting the sound source separator.

FIG. 4 is a diagram illustrating an example of sound source separation by a plurality of sound source separators, according to an embodiment of the disclosure.

Referring to FIGS. 3 and 4, when a sound source separation request for an original sound source (input) occurs, the server processor 250 may select at least one sound source separator from the plurality of sound source separators 232 stored in the server memory 230 (or a plurality of sound source separators stored in an external server device) and may perform sound source separation on the original sound source (input) based on the selected sound source separator. According to an embodiment, the main configuration of a sound source separator may include basic information (e.g., at least one of a name, a version, url (including local), a size, or dependency (requirement) library), an input type (e.g., data, a format, a sampling rate, and a channel), and an output type (e.g., data, a format, a sampling rate, and a channel (information)).

Referring to the illustrated drawings as an example, the plurality of sound source separators 232 may at least include the first sound source separator 232a and the second sound source separator 232b. The server processor 250 may select the first sound source separator 232a and the second sound source separator 232b in relation to sound source separation for the original sound source (input) under a specified condition. The server processor 250 may generate the first edit sound source 233a and the second edit sound source 233b by separating a sound source from the original sound source (input) by using the selected sound source separators 232a and 232b. According to an embodiment, the first edit sound source 233a may include voices and BGM sound source elements. The second edit sound source 233b may include a guitar, a piano, drums, and other sound source elements. The server processor 250 may generate parameter information for sound source elements of the first edit sound source 233a that is generated, may include the parameter information in the first edit sound source 233a, and may store the first edit sound source 233a in the server memory 230. In this operation, the server processor 250 may include information about the original sound source (input) in the first edit sound source 233a and may store the first edit sound source 233a. For example, the parameter information included in the first edit sound source 233a may at least include identification information of the first sound source separator 232a, types of sound source elements, and information about the number of sound source elements.

Moreover, the server processor 250 may generate parameter information about sound source elements of the generated the second edit sound source 233b, may include the parameter information in the second edit sound source 233b, and may store the second edit sound source 233b in the server memory 230. Moreover, the server processor 250 may include information about the original sound source (input) in the second edit sound source 233b and may store the second edit sound source 233b. For example, the parameter information included in the second edit sound source 233b may at least include identification information of the second sound source separator 232b, types of sound source elements, and information about the number of sound source elements.

In the meantime, in the above descriptions, it is described that the server processor 250 selects the first sound source separator 232a and the second sound source separator 232b, but the disclosure is not limited thereto. For example, the server processor 250 may select only one sound source separator among the first sound source separator 232a and the second sound source separator 232b under a specified condition. In response, one of the first edit sound source 233a separated by the first sound source separator 232a and the second edit sound source 233b separated by the second sound source separator 232b may be stored in the server memory 230. According to an embodiment, the plurality of sound source separators may include a third sound source separator capable of separating at least one of multiple speakers, chorus, acoustic, electronic sound, spatial sound, sound effects, or noise as a sound source element, and may separate at least one of the above-described sound source elements as a sound source in this way.

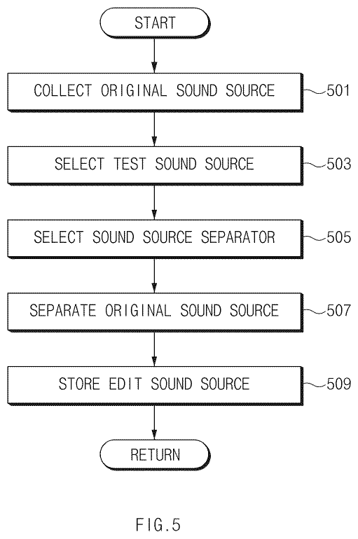

FIG. 5 is a diagram illustrating an example of a method of operating a plurality of sound source separators, according to an embodiment of the disclosure.

Referring to FIG. 5, in connection with a method of operating a plurality of sound source separators according to an embodiment, in operation 501, the server processor 250 (or the processor 150 of the electronic device 100, hereinafter described based on the server processor 250) of the server device 200 may control collection of an original sound source. For example, the original sound source may be provided by the electronic device 100, or the original sound source stored in the server memory 230 may be selected or may be received from an external server device. In this regard, the server processor 250 may provide a menu item for uploading the original sound source onto the electronic device 100 while a communication channel with the electronic device 100 is established, and may receive the original sound source from the electronic device 100 through the corresponding menu item. When the server processor 250 receives the original sound source from the electronic device 100, the server processor 250 may temporarily or semi-permanently store the received original sound source in the server memory 230. According to an embodiment, the server processor 250 may provide the electronic device 100 with a list screen for selecting the original sound source to be used for sound source separation, and a user may select a specific original sound source on the list screen. In this operation, the server processor 250 may provide a pre-listening function for an original sound source capable of being selected by the user of the electronic device 100. The electronic device 100 may receive and output the original sound source stored in the server memory 230 in a streaming manner or may download and play the original sound source. The server processor 250 may receive a search word for a specific original sound source from the electronic device 100. When the original sound source corresponding to the search word is not stored in the server memory 230, the server processor 250 may receive the original sound source corresponding to the search term from an external server device.

In operation 503, the server processor 250 may select a test sound source. In relation to selecting the test sound source, the server processor 250 may identify sound information (or meta information) of the original sound source selected by the user of the electronic device 100, and may select a test sound source having sound information identical to or similar to the sound information from a plurality of test sound sources. When the sound information is not present in the original sound source, the server processor 250 may select the test sound source having a similar waveform by analyzing the waveform of a signal included in the original sound source. In this operation, the server processor 250 may sample at least part of the entire interval of the original sound source and may select the test sound source having a sample interval identical or similar to the sampled interval. The test sound sources 231 pre-stored in the server memory 230 may be matched with the optimized (or the degree of distortion is less than a reference value, or is the lowest compared to other sound source separators) sound source separator. The server memory 230 may store and manage a table matching the test sound sources 231 with the optimal sound source separator. When the server processor 250 downloads and installs a new sound source separator from an external server device, the server processor 250 may perform sound source separation on the test sound sources 231, may evaluate the sound source separation results to determine the optimal test sound source, and may update the matching table.

When the test sound source is selected, in operation 505, the server processor 250 may select a sound source separator. In this regard, the server processor 250 may identify the matching table pre-stored in the server memory 230, and may select a sound source separator having optimal performance (or performance having a specified reference value or higher, or performance indicating the degree of distortion lower having less than a reference value) for the selected test sound source among a plurality of sound source separators. For example, the sound source separator selection unit 253 may calculate scores for a quality item (eval: SNR, SDR, SIR and similarity after sound effect by test) corresponding to quality performance quantitative values from the sound source separation results performed previously (or performed by using the test sound source), a time (inference) item corresponding to the execution speed when a sound source is separated, a size (memory) item corresponding to the memory size used when a sound source is separated, and a system (capa) item (e.g., at least one of a central processing unit (CPU), a graphic processing unit (GPU), a neural processing unit (NPU) or a network element) corresponding to the performance indicator in a system, and may select a sound source separator to be used for sound source separation for the original sound source or sound field effect for the edit sound source based on the final score.

In operation 507, the server processor 250 may create an edit sound source by separating the original sound source by using the selected sound source separator. When a plurality of sound source separators are selected in operation 505, the server processor 250 may create a plurality of edit sound sources. The edited sound source may include a plurality of sound source elements.

In operation 509, the server processor 250 may control the storage of the edit sound source. For example, the server processor 250 may store the edit sound source in the server memory 230. According to an embodiment, the server processor 250 may provide the electronic device 100 with an edit sound source in response to a sound source separation request for an original sound source of the electronic device 100. When the plurality of edit sound sources for the original sound source are created, the server processor 250 may provide the plurality of edit sound sources to the electronic device 100. Alternatively, the server processor 250 may provide a list of edit sound sources to the electronic device 100 and may provide the electronic device 100 with the edit sound source according to the user's selection.

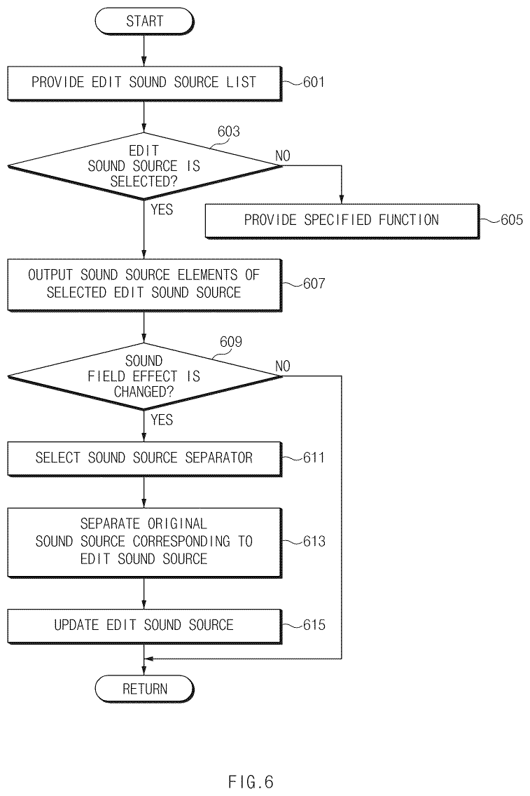

FIG. 6 is a diagram illustrating an example of a method of operating a plurality of sound source separators, according to an embodiment of the disclosure.

Referring to FIG. 6, in connection with a method of operating a plurality of sound source separators according to an embodiment, in operation 601, the server processor 250 (or the processor 150 of the electronic device 100, hereinafter described based on the server processor 250) of the server device 200 may provide a predefined access screen (or a web page) to the electronic device 100 when the electronic device 100 is accessed. For example, the access screen may include an edit sound source list stored in the server memory 230. The electronic device 100 may display the received edit sound source list on a display and may transmit, to the server device 200, the edit sound source selected in response to a user input.

In operation 603, the server processor 250 may determine whether the electronic device 100 selects the edit sound source. According to an embodiment, the access screen provided in the electronic device 100 may further include a menu item for selecting an original sound source separating function, a menu item related to the playback of the original sound source, or the like. Accordingly, when the user input is not an input for selecting an edit sound source, in operation 605, the server processor 250 may provide a specified function according to the user input. For example, the server processor 250 may support functions related to a specific sound source such as an original sound source searching function, an original sound source playing function, and an original sound source separating function.

When the user input received from the electronic device 100 is an input for selecting an edit sound source, in operation 607, the server processor 250 may output sound source elements of the selected edit sound source. In this operation, the server processor 250 may generate a list corresponding to a plurality of sound source elements of the edit sound source, and may provide the generated sound source element list to the electronic device 100. According to an embodiment, the sound source element list may include at least one of the types of sound source elements, whether sound field effects are applied to sound source elements, and the types of sound field effects applied to sound source elements. The electronic device 100 may transmit, to the server device 200, a message for instructing a change in the sound field effect of a specific sound source element in response to a user input.

In operation 609, the server processor 250 may determine whether a user input related to a sound field effect change occurs. When receiving a user input regarding a change in the sound field effect of a specific sound source element, in operation 611, the server processor 250 may select a sound source separator. In this operation, in applying a sound field effect to a sound source element selected by a user, the server processor 250 may select a sound source separator, which provides performance (or optimal performance) of a predetermined reference value or higher, from among a plurality of sound source separators. In this regard, the server memory 230 may store sound field effect information and a sound source element, through which each sound source separator is capable of providing high performance, in a table form. The server processor 250 may select a sound source separator for providing a sound source element and a sound field effect, which are selected in response to the user input, by identifying an information table stored in the server memory 230.

When a sound source separator is selected, the server processor 250 may identify the original sound source corresponding to an edit sound source. In operation 613, the server processor 250 may perform the separation task of the original sound source corresponding to the edit sound source by using the selected sound source separator. The server processor 250 may extract a plurality of sound source elements by performing a sound source separation task from the original sound source, and then may create a new edit sound source to which a sound field effect selected by the user is applied to the extracted sound source elements.

In operation 615, the server processor 250 may update the newly created edit sound source to the server memory 230. In the update operation, while deleting a pre-stored edit sound source and storing a new edit sound source or keeping a previous edit sound source, the server processor 250 may add the new edit sound source. The server processor 250 may provide the new edit sound source to the electronic device 100.

In the meantime, in the above description, it is described that the original sound source is separated by using a newly selected sound source separator to apply a specified sound field effect to at least one sound source element, which is selected by the user, from among sound source elements included in the edit sound source, but the disclosure is not limited thereto. For example, the server processor 250 may apply a sound field effect requested by the user to sound source elements included in the previous edit sound source, and a new edit sound source according to the sound field effect may be generated under the control of the server processor 250.

According to an embodiment, the server processor 250 may provide the user of the electronic device 100 with a new edit sound source registered by the user of another electronic device. As such, the server processor 250 may support other users such that the other users share the form for editing or re-editing a specific original sound source or an edit sound source, through a function for sharing or recommending the edit sound source. Moreover, the server processor 250 may apply a voting function (or a scoring function) to at least one edit sound source, such that the other users may check and view the edit sound source having a relatively good score.

In the meantime, in the descriptions given in FIGS. 5 and 6, the original sound source edit function and the edit sound source using function are described based on the server processor 250, but the above-described operations of FIGS. 5 and 6 may be identically applied to the operations of the processor 150 of the electronic device 100.

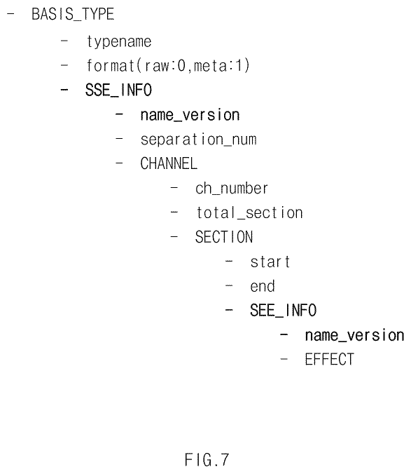

FIG. 7 is a diagram showing an example of a metadata format according to sound source editing, according to an embodiment of the disclosure.

Referring to FIG. 7, according to an embodiment of the disclosure, the server device 200 may generate an edit sound source by performing sound source separation on an original sound source, and may record parameters for the generated edit sound source in a form of a structure as illustrated. The illustrated structure may include factors arguments for generating information about the edit sound source. According to an embodiment, the structure is defined as being in BASIC_TYPE, and the BASIC_TYPE may include items of typename, format (raw: 0, meta: 1), and SSE_INFO. The typename may include name or title information of the generated edit sound source. For example, a title entered by a user or a title randomly selected by the server processor 250 may be recorded in the typename. Alternatively, the name of an original sound source or the name of a test sound source may be written in the typename item. The format (raw: 0, meta: 1) may be written according to the type of the corresponding sound source. For example, in the case of the original sound source, ‘0’ may be written in a format item position. In the case of the edit sound source, ‘1’ may be written in the format item position. The name of a sound source separator used to separate a sound source may be written in the SSE_INFO item. In the meantime, in relation to the sound source separator, name_version, separation_num, and CHANNEL items may be written in the SSE_INFO. The name and version number of the sound source separator may be written in the name_version item. The number of separated sound source elements may be written in the Separation_num item. As shown in drawing, the CHANNEL item may include ch_number, total_section, and SECTION items. A channel number may be written in the ch_number item, and information about the total number of sections may be written in the total_section item. The SECTION item may include start, end, and SEE_INFO items. The start number of the section may be written in the start item, and the end number of the section may be written in the end item. The SEE_INFO item may include name_version and EFFECT items. The name and version of the applied sound field effector (or an application service, an application program, or an application, such as an effect module, a sound source characteristic change module, or an editing module) may be written in the name_version item. The sound field effect applied through a sound field effector may be written in the EFFECT item.

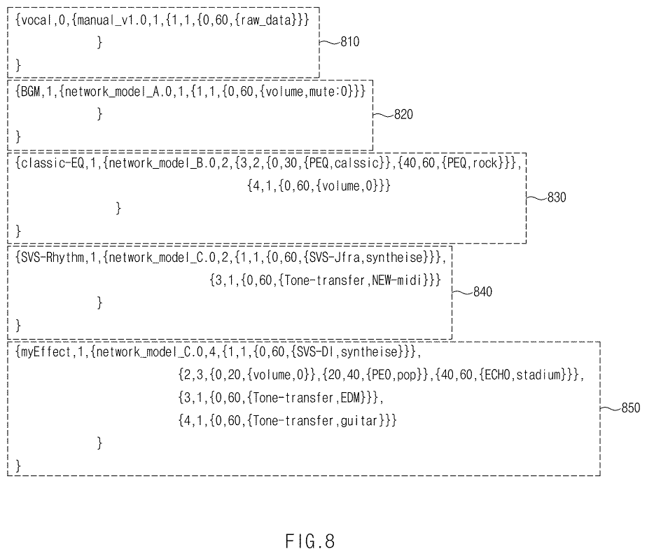

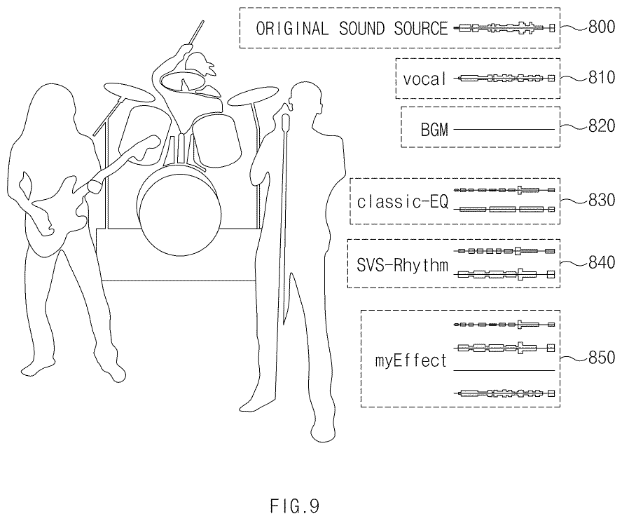

FIG. 8 is a diagram showing various examples of a metadata format according to sound source editing, according to an embodiment of the disclosure. FIG. 9 is a diagram showing an example of sound source elements according to sound source editing, according to an embodiment of the disclosure.

Referring to FIGS. 7 and 8, as described above in FIG. 7, the server processor 250 may write parameter information in relation to sound source separation. Referring to FIG. 8, the server processor 250 may write at least one of various types of parameter information. According to an embodiment, the server processor 250 may write at least one of first to fifth parameter information 810, 820, 830, 840, and 850. The first parameter information 810 may be parameter information where vocal is written as BASIC_TYPE, and may indicate that a sound source separator manual_v1.0 is used for the original sound source (raw: 0), there is one separated sound source element, the channel number is 1, there is one section in total, the start and end of the section are defined as 0 and 60, and raw_data (no separate sound field effect is applied) as a sound field effect is applied.

The second parameter information 820 may be parameter information where BGM is written as BASIC_TYPE, and may indicate that a sound source separator network_model_A is used for an edit sound source (meta: 1), there is one separated sound source element, the channel number is 1, there is one section in total, the start and end of the section are defined as 0 and 60, and a volume sound field effect is set to “mute: 0”.

The third parameter information 830 may be parameter information where classic-EQ is written as BASIC_TYPE, and may define a state where a sound source separator network_model_B is used for an edit sound source (meta: 1), there are two separated sound source elements, the channel number of the first sound source element among the two sound source elements is 3, there are two sections in total, the start and end of a section are defined as 0 and 30, and “rock” is applied through a PEG sound field effector to a section interval, to which “classic” is applied by using a sound field effector PEQ device, and a section interval defined from 40 to 60. Furthermore, the third parameter information 830 may define a state where the second sound source element among the two sound source elements has channel number of 4, there is one section, the start and end of the section are defined as 0 and 60, and the volume of a sound field effector is set to 0 (e.g., a state where a sound field effect is not applied).

The fourth parameter information 840 may be parameter information where SVS-Rhythm is written as BASIC_TYPE, and may define a state where a sound source separator network_model_C is used for an edit sound source (meta: 1), there are two separated sound source elements, the channel number of the first sound source element among the two sound source elements is 1, there is one section in total, the start and end of a section are defined as 0 and 60, and a sound field effect “NEW-midi” of a sound field effector Tone-transfer is applied.

The fifth parameter information 850 may be parameter information where my-Effect is written as BASIC_TYPE, and may define a state where a sound source separator network_model_C is used for an edit sound source (meta: 1), there are four separated sound source elements, the first sound source element among the four sound source elements has channel number of 1, there is one section in total, the start and end of the section are defined as 0 and 60, a sound field effect synthesize of the sound field effector SVS-DJ is applied. The fifth parameter information 850 may define a state where the channel number of the second sound source element among the four sound source elements is 2, there are three sections in total, the start and end of the first section are defined as 0 and 20, the volume of a sound field effector is applied as 0, the start and end of the second section are defined as 20 and 40, a sound field effect “pop” of a sound field effector PEG is applied, the start and end of the third section are defined as 40 and 60, and a sound field effect “stadium” of a sound field effector ECHO is applied. The fifth parameter information 850 defines a state where the channel number of the third sound source element among the four sound source elements is 3, there is one section in total, the start and end of the section are defined as 0 and 60, and a sound field effect EDM of a sound field effector Tone-transfer is applied. The fifth parameter information 850 may define a state where the channel number of the fourth sound source element among the four sound source elements is 4, there is one section in total, the start and end of the section are defined as 0 and 60, and a sound field effect guitar of a sound field effector Tone-transfer is applied.

Referring to FIG. 9, the server processor 250 may display parameter information of various sound sources described in FIG. 8 in a simple form as illustrated. According to an embodiment, an original sound source 800 may be displayed as a single audio waveform as illustrated. The first parameter information 810 corresponding to a first edit sound source may be displayed as an audio waveform corresponding to a voice (vocal) being one sound source element. The second parameter information 820 corresponding to a second edit sound source may be displayed as an audio waveform corresponding to BGM being one sound source element. The third parameter information 830 corresponding to a third edit sound source may have title classic-EQ and may be displayed as audio waveforms corresponding to two sound source elements. The fourth parameter information 840 corresponding to a fourth edit sound source may have title SVS-Rhythm and may be displayed as audio waveforms corresponding to two sound source elements. The fifth parameter information 850 corresponding to a fifth edit sound source may have title myEffect and may be displayed as audio waveforms corresponding to four sound source elements. The server processor 250 may vary the color and size of the audio waveform displayed depending on at least one of the type of sound field effector used or the type of a sound source element.

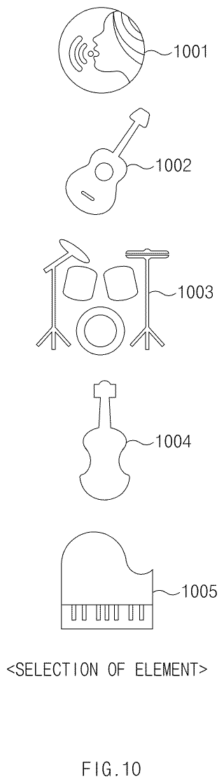

FIG. 10 is a diagram illustrating an example of providing an object related to selecting a sound source element, according to an embodiment of the disclosure.

When the electronic device 100 accesses the server device 200, the server device 200 may provide the electronic device 100 with a screen including at least one item among an item related to editing the original sound source (e.g., sound source separation) and an item for searching for edited sound sources. The user of the electronic device 100 may select one edit sound source among the edited sound sources on a screen provided by the server device 200; an input signal corresponding to a user's selection may be provided to the server device 200; and the server device 200 may provide a screen corresponding to the edit sound source selected by the user to the electronic device 100.

According to an embodiment, referring to FIG. 10, the server device 200 may provide the electronic device 100 with a screen including five sound source elements 1001, 1002, 1003, 1004, and 1005 in response to a user input for selecting a specific edit sound source among the edited sound sources. For example, the five sound source elements 1001, 1002, 1003, 1004, and 1005 of the edit sound source according to the user's selection may include the voice sound source element 1001, the guitar sound source element 1002, the drum sound source element 1003, the violin sound source element 1004, and the piano sound source element 1005. The sound source elements 1001, 1002, 1003, 1004, and 1005 output to the display 140 of the electronic device 100 may be output in a form of specific icons as illustrated, but the disclosure is not limited thereto. For example, text for describing icons (e.g., a voice, a guitar, drums, a violin, and a piano) respectively corresponding to the sound source elements 1001, 1002, 1003, 1004, and 1005 output to the electronic device 100 in addition to the icons may be output adjacent to the icons.

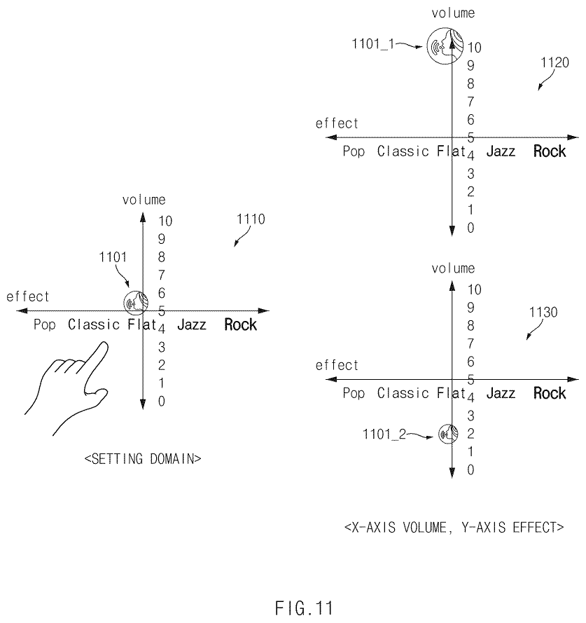

FIG. 11 is a diagram illustrating an example of a screen interface related to adjustment of a sound field effect of a single sound source element, according to an embodiment of the disclosure.

Referring to FIGS. 10 and 11, the server device 200 (or the electronic device 100) may provide functions for applying the sound field effect and volume of a specific sound source element. According to an embodiment, as illustrated in state 1110, the server device 200 may output an adjustment object related to adjusting of the volume and sound field effect of a voice sound source element object 1101. For example, the adjustment object may be configured to adjust the volume of the voice sound source element in a vertical direction (or x-axis direction), and to change the sound field effect (e.g., Pop, Classic, Flat, Jazz, and Rock) of the voice sound source element in a horizontal direction (or y-axis direction) (e.g., an application service, an application program, or an application such as an effect module, a sound source characteristic change module, and an editing module).

According to an embodiment, as illustrated in state 1120, a user of the electronic device 100 may vertically move the voice sound source element object 1101 to the top to adjust the volume of the voice sound source element. Alternatively, as illustrated in state 1130, a user of the electronic device 100 may vertically move the voice sound source element object 1101 to the bottom to adjust the volume of the voice sound source element. When the voice sound source element object 1101 in state 1110 is moved upwardly in a vertical direction as illustrated in state 1120, the server device 200 (or the electronic device 100) may adjust the setting of the sound source element such that the volume of the voice sound source element increases, and may output a first voice sound source transformation object 1101_1 upwardly in the vertical direction in response to the volume increase setting. For example, the first voice sound source transformation object 1101_1 may be displayed such that the size of the first voice sound source transformation object 1101_1 is greater than the voice sound source element object 1101.

When the voice sound source element object 1101 in state 1110 is moved downwardly in the vertical direction as illustrated in state 1130, the server device 200 (or the electronic device 100) may adjust the setting of the sound source element such that the volume of the voice sound source element decreases, and may output a second voice sound source transformation object 1101_2 downwardly in the vertical direction in response to the volume decrease setting. For example, the second voice sound source transformation object 1101_2 may be displayed such that the size of the second voice sound source transformation object 1101_2 is smaller than the voice sound source element object 1101.

In the meantime, as described in FIG. 11, it is described that the volume of the voice sound source element is adjusted, but other sound source elements may also be adjusted through the adjustment object described in FIG. 11. For example, when a user input for selecting a specific sound source element among the five sound source elements 1001, 1002, 1003, 1004, and 1005 illustrated in FIG. 10 occurs, the server device 200 (or the electronic device 100) may output an adjustment object capable of adjusting at least one of the volume or sound field effect for the selected sound source element, and the at least one of the volume or sound field effect may be adjusted depending on the movement of the sound source element as described in FIG. 11.

According to various embodiments, the adjustment object capable of adjusting the volume and the sound field effect is presented in the above-described FIG. 11, but the server device 200 (or the electronic device 100) of the disclosure may provide only one of a vertical adjustment object for adjusting the volume or a horizontal adjustment object for adjusting the sound field effect.

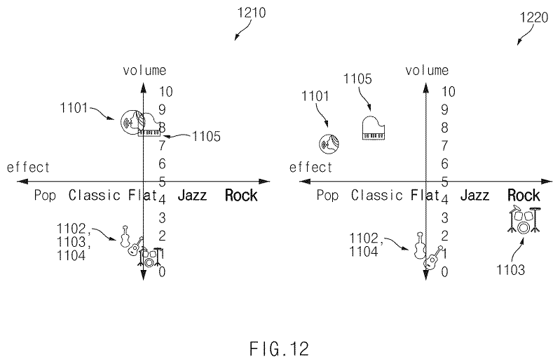

FIG. 12 is a diagram illustrating an example of a screen interface related to adjustment of a sound field effect of multiple sound source elements, according to an embodiment of the disclosure.

Referring to FIGS. 10 to 12, as described above in FIG. 10, the server device 200 (or the electronic device 100) according to an embodiment may output the sound source elements 1001, 1002, 1003, 1004, and 1005 included in an edit sound source selected by a user. While the plurality of sound source elements 1001, 1002, 1003, 1004, and 1005 are output, the user may select the plurality of sound source elements in relation to adjusting at least one of the volume or the sound field effect of a sound source element. For example, the user may select all five sound source elements to adjust the at least one of the volume or the sound field effect of all five sound source elements described in FIG. 10.

In response thereto, the server device 200 (or the electronic device 100) may provide a function for applying the volume and sound field effect of the plurality of sound source elements. According to an embodiment, the server device 200 may output an adjustment object capable of adjusting the volume and sound field effect of each of the voice sound source element object 1101, a piano sound source element object 1105, a guitar sound source element object 1102, a violin sound source element object 1104, and a drum sound source element object 1103. As illustrated in state 1210, the user of the electronic device 100 may set the volume of the voice sound source element object 1101 and the piano sound source element object 1105 so as to be relatively higher than the volume of other sound source elements (e.g., a guitar, a violin, or drums). As described above in FIG. 11, the server device 200 (or the electronic device 100) may display the sizes of the sound source element objects differently depending on a location on the vertical setting line.

According to an embodiment, as illustrated in state 1220, the volume and sound field effect of at least one sound source element may be adjusted simultaneously. For example, when the voice sound source element object 1101 is positioned at a left edge (e.g., a location corresponding to a Pop sound field effect) as shown while being placed above a horizontal line, the volume level of the voice sound source element may be set to be higher than the volume level of the sound source element positioned on the horizontal line, and the Pop effect may be applied as a sound field effect. As shown, when the piano sound source element object 1105 is positioned in the second quadrant corresponding to a location on the left side (e.g., the location corresponding to the Classic sound field effect) while being placed above the horizontal line, the volume level of the piano sound source element may be set higher than the volume level of the voice sound source element, and the Classic effect may be applied as a sound field effect. As shown, when the drum sound source element object 1103 is placed in the fourth quadrant corresponding to a right edge location (e.g., the location corresponding to the Rock sound field effect) while being placed below the horizontal line, the volume level of the drum sound source element may be set lower than the volume level set on the horizontal line or the volume level of the voice sound source element, and the Rock effect may be applied as a sound field effect. As shown, the violin sound source element object 1104 and the guitar sound source element object 1102 may be located at the lower side of a vertical line, and “Flat” may be set as a sound field effect. Here, the “Flat” sound field effect may include settings where no separate sound field effect is applied. In response thereto, the volume of each of the violin sound source element and the guitar sound source element may be set to minimum. As described above, when the same settings as in state 1220 are applied, the violin and guitar sound source elements in the edit sound source described in FIG. 10 may be removed, “POP” effect may be applied to a voice, a sound may be played at a volume level between a piano and a drum, the piano may be played at the highest volume while “Classic” effect is applied, and the drum may be played at a lower volume than the voice while “Rock” effect is applied. Referring to adjustment object settings in state 1220, the server device 200 (or the electronic device 100) may change color when applying a specific sound field effect.

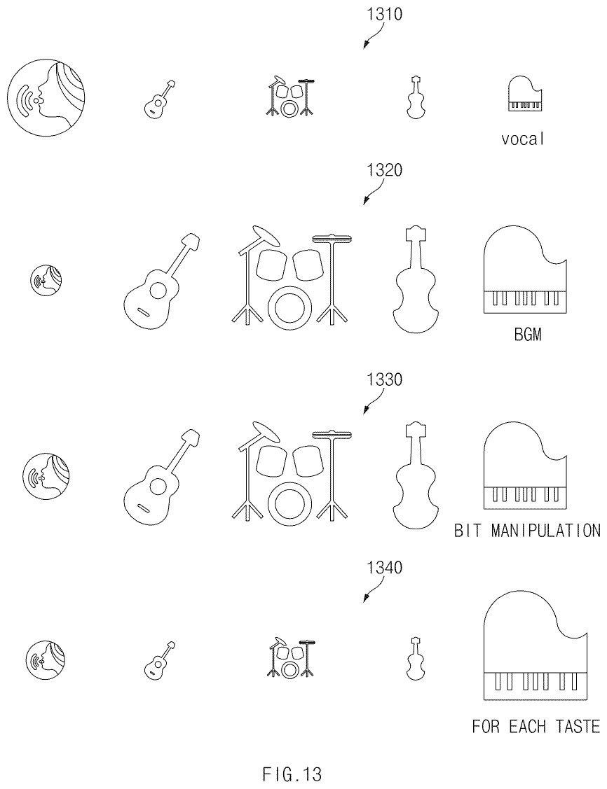

FIG. 13 is a diagram showing an example of a screen interface for applying a sound field effect for each sound source element, according to an embodiment of the disclosure.

Referring to FIGS. 12 and 13, as described above in FIG. 12, the sound field effect of a specific sound source element may be changed or adjusted by placing an object corresponding to a specific sound source element at a location corresponding to a specific sound field effect of a horizontal line.

According to an embodiment, when only a voice (vocal) is to be emphasized, a user of the electronic device 100 may perform the same settings as in state 1310. For example, state 1310 may include a state where the volume of the voice sound source element is set to the maximum and the volume level of other sound source elements (e.g., a guitar sound source element, a drum sound source element, a violin sound source element, and a piano sound source element) are set to the minimum.

According to an embodiment, when only BGM is to be emphasized, a user of the electronic device 100 may perform the same settings as in state 1320. For example, state 1320 may include a state where the volume of the voice sound source element is set to the minimum and the volume level of other sound source elements (e.g., a guitar sound source element, a drum sound source element, a violin sound source element, and a piano sound source element) are set to the maximum.

According to an embodiment, when adjusting bits of sound source elements, the user of the electronic device 100 may perform the same settings as in state 1330. For example, state 1330 may include a state where no separate sound field effect is applied (or setting to “Flat”) while the volume of the voice sound source element, the guitar sound source element, the violin sound source element, and the piano sound source element is set to the maximum, and the volume of the drum sound source element is set to the maximum while “Rock” sound field effect is applied.

According to an embodiment, when various types of sound sources are adjusted depending on the user's settings, the user of the electronic device 100 may perform the same settings as in state 1340. For example, state 1340 may include a state where the Pop sound field effect is applied while the volume level of the voice sound source element is set to be lower than the volume level of the piano sound source element and higher than the other sound source elements, the Classic sound field effect is applied while the volume level of the piano sound source element is set to the maximum, and the volume levels of other sound source elements (e.g., the guitar sound source element, the drum sound source element, and the violin sound source element) are set to the minimum.

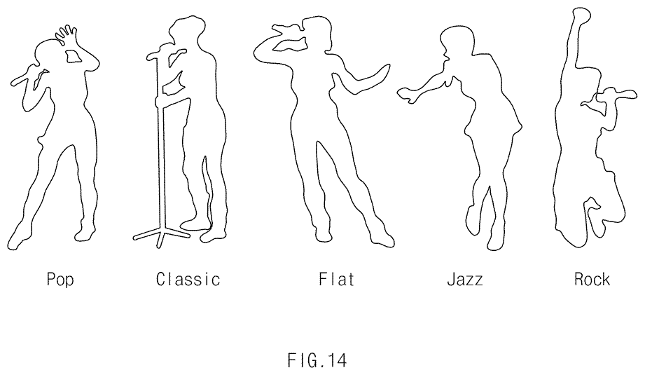

FIG. 14 is a diagram showing an example of a screen interface related to a sound field effect, according to an embodiment of the disclosure.

Referring to FIG. 14, when the sound field effects as described in FIGS. 11 to 13 are additionally or separately expressed with specific text or color in the operation of applying a sound field effect, the server device 200 (or the electronic device 100) may use specific poses or gesture shapes in relation to the expression of the specific sound field effect. According to an embodiment, the server device 200 (or the electronic device 100) may assign an image corresponding to a specific pose or gesture of a person corresponding to each of Pop, Classic, Flat, Jazz, and Rock sound field effects, may replace the image with icons provided to apply the sound field effects described in FIGS. 11 to 13, and may output the icons.

A user of the electronic device 100 may identify a specific pose or gesture (or identify text placed below the specific pose or gesture) and may select the sound field effect to be applied.

When receiving a user input related to adjusting the sound field effect of a specific sound source element in the above-described FIGS. 10 to 14, the server device 200 (or the electronic device 100) may select an appropriate sound source separator to apply the sound field effect selected by the user to the corresponding sound source element. In this regard, in applying a specific sound field effect to a specific sound source element, the server device 200 (or the electronic device 100) may store and manage a list of sound source separators or sound field effectors for providing a performance indicator (or an optimal performance indicator) of a reference value or more. The server device 200 (or the electronic device 100) may perform a related function by identifying a pre-stored list, and selecting a sound field effector or sound source separator for applying a sound field effect to a specific sound source element. In this operation, when selecting a sound source separator, the server device 200 (or the electronic device 100) may obtain an original sound source corresponding to an edit sound source, and may process sound source separation for the obtained original sound source and application of a sound field effect to a sound source element selected by the user among the sound source separated sound source elements.

In the meantime, it is described that a sound source separator is selected and an edit sound source is generated by the server device 200, but the description is not limited thereto. For example, instead of the server processor 250 of the server device 200, the processor 150 of the electronic device 100 may process at least one function of selecting a sound source separator, creating an edit sound source, selecting a new sound source separator for a specific sound source element in the edit sound source, separating a sound source of an original sound source by using the newly selected sound source separator, and updating a new edit sound source obtained by applying a sound field effect according to the user's selection to a sound source element. According to an embodiment, the sound source separating function of the disclosure may be provided by the electronic device 100 itself without connection to the server device 200. In this case, the electronic device 100 may store a plurality of sound source separators and at least one edit sound source in the memory 130, and may provide a sound source separator selecting function or a re-edit function for the edit sound source. In this regard, as an application supporting at least one of the sound source separator selecting function and the re-edit function described above is installed, and the corresponding application is launched, the electronic device 100 may support a screen interface providing function related to sound field effect editing in FIGS. 10 to 14 described above.

With respect to sound field effects after an optimal sound source separator is selected as described above in FIGS. 7 to 9, the sound source separator selecting function and the edit sound source using function of the disclosure described above may be applied in a form of metadata. In this disclosure, when conditions and arguments of sound source elements of a sound to be edited are given in a system including a plurality of different sound source separators, it is possible to select an appropriate sound source separator and to extract sound source elements, thereby providing a sound field effect. In this disclosure, the sound field effects of the edit sound source recorded in the form of metadata may be played in a single or mixed method, and the corresponding data may be operated such that one or more processors or devices of a plurality of terminals (a mobile, an AR, and a server) may share, add, and update the corresponding data.

Through the above-described user function of the disclosure, an effect (a sound field effect) may be applied to each separated sound source, and a model in which sound source separation and a sound field effect modules are separated or integrated may be used. Additionally, in the disclosure, adjustments such as frequency, pitch, and reverb may also be supported in relation to the sound field effect adjusting function. In this disclosure, the settings of individual or selected sound sources may be changed simultaneously, and separate effects suitable for sound source characteristics may be provided or recommended. A device (e.g., the server device 200 or the electronic device 100) of the disclosure may support recording one or more of setting values changed in the edit sound source or re-edit sound source operation in accordance with a file format (metainfo), and may support selecting and listening to a plurality of sound sources during playback. The device of the disclosure supports displaying setting values in various ways and applying an effect (e.g., pitch, style-transfer, svs, or sound effect engine (SEE)) to tone. Moreover, the disclosure may support a translation function (e.g., a function that generates and provides a script for a voice (vocal) for a language, and may support the creation of a vocal from the script. The material may apply effects to the sense of space (Spatial), and may support at least one function of a function of applying sound field effects overlapping, storing, sharing, and updating the set sound field effect, and differently applying the set sound field effect for each sound source, a function of differently displaying a sound source depending on a song, a function of providing a recommendation function accordingly when user preference information is collected, and differently applying effects to an image according to the sound source, a sound source recommending function according to the image, a ranking function for a setting sound field effect, a tag adding function, and a function of displaying and transferring copyright.

According to an embodiment of the disclosure, a method of providing a sound source edit function (or a method for processing a sound source of content data) may include receiving an original sound source including a plurality of sound source elements, selecting a pre-stored test sound source corresponding to the original sound source from a plurality of pre-stored test sound sources, the plurality of test sound sources each being matched to at least one of a plurality of sound source separators according to a performance indicator, selecting at least one sound source separator, which corresponds to separation of the test sound source, from among the plurality of sound source separators, extracting a plurality of sound source elements by separating the original sound source by using the selected at least one sound source separator, and storing an edit sound source including the extracted plurality of sound source elements. At least one of operations described above may be performed by a server device or an electronic device.

According to an embodiment, the selecting of the at least one sound source separator may include determining the at least one sound source separator based on at least one of a degree of distortion of the plurality of sound source separators for at least one test sound source among the plurality of test sound sources, a speed at which the plurality of sound source separators perform sound source separation, or a hardware resource usage amount of the plurality of sound source separators.

According to an embodiment, the performance indicator includes at least one of a source to distortion ratio (SDR), a sources to artifacts ratio (SAR), a signal to interference ratio (SIR), a signal to noise ratio (SNR), and similarity with a target value.

According to an embodiment, the method may include, when a plurality of sound source separators are selected in the selecting of the at least one sound source separator, extracting sound source elements by using each sound source separator in the extracting of the plurality of sound source elements.

According to an embodiment, the method may further include storing metadata related to the edit sound source. The metadata may include at least one of a name of a sound source separator applied to sound source separation of the original sound source, a number of the sound source elements, a type of the sound source elements, or a name of a sound field effector applied to the sound source elements.

According to an embodiment, the method may further include providing at least one edit sound source list stored, receiving a user input for selecting a specific edit sound source included in the edit sound source list, and outputting at least one sound source element included in the selected specific edit sound source.

According to an embodiment, the method may include receiving a user input for adjusting a sound field effect of a specific sound source element, obtaining an original sound source corresponding to the selected specific edit sound source, selecting a new sound source separator related to adjusting a sound field effect of the specific sound source element, performing sound source separation on the original sound source by using the new sound source separator, generating a new edit sound source by applying the sound field effect to a sound source element, which is selected by the user, from among the sound source-separated sound source elements, and outputting the new edit sound source.

According to an embodiment, the selecting of the new sound source separator may include obtaining a matching table with a sound source separator that provides a performance indicator of a specified reference value or higher in the applying of a sound field effect to the specific sound source element, and selecting the new sound source separator based on the matching table.

According to an embodiment, the method may further include providing a screen interface capable of adjusting at least one of a volume or a sound field effect of the at least one sound source element.

According to an embodiment, the method may further include differently outputting at least one of an object size, color, or a shape corresponding to the at least one sound source element in response to adjusting the volume and the sound field effect of the at least one sound source element.

According to an embodiment of the disclosure, a method for providing a sound source edit function (or a method for processing a sound source of content data) may include obtaining a sound source-separated edit sound source, providing a screen for selecting a sound field effect for at least one element among separated elements included in the edit sound source, receiving a user input for selecting a sound field effect, selecting a sound source separator optimized for a sound field effect selected by a user input among a plurality of sound source separators, and generating and storing a new edit sound source by separating an original sound source corresponding to the edit sound source by using the selected sound source separator. At least one of operations described above may be performed by a server device or an electronic device.

According to an embodiment of the disclosure, a method of providing a sound source edit function (or a method for processing a sound source of content data) may include receiving an original sound source including a plurality of sound source elements, selecting a pre-stored test sound source corresponding to the original sound source from a plurality of pre-stored test sound sources, the plurality of test sound sources each being matched to at least one of a plurality of sound source separators according to a performance indicator, selecting a sound source separator that satisfies predefined sound source separation performance speed and a hardware resource usage amount among a plurality of sound source separators matching the test sound source, extracting a plurality of sound source elements by separating the original sound source by using the selected sound source separator, and storing an edit sound source including the extracted plurality of sound source elements.

According to an embodiment of the disclosure, a method of providing a sound source edit function (or a method for processing a sound source of content data) may include receiving, by an electronic device, an edit sound source list in which sound sources are separated, selecting a specific edit sound source from the edit sound source list, displaying a sound field effect list capable of being applied to the selected specific edit sound source, and receiving a new edit sound source in which a sound field effect of the selected edit sound source is adjusted based on a sound field effect application corresponding to a selected item when the specific item among the sound field effect list is selected. The operations related to the method of providing a sound source edit function may be processed within the electronic device itself or through a screen interface provided to the electronic device by a server.

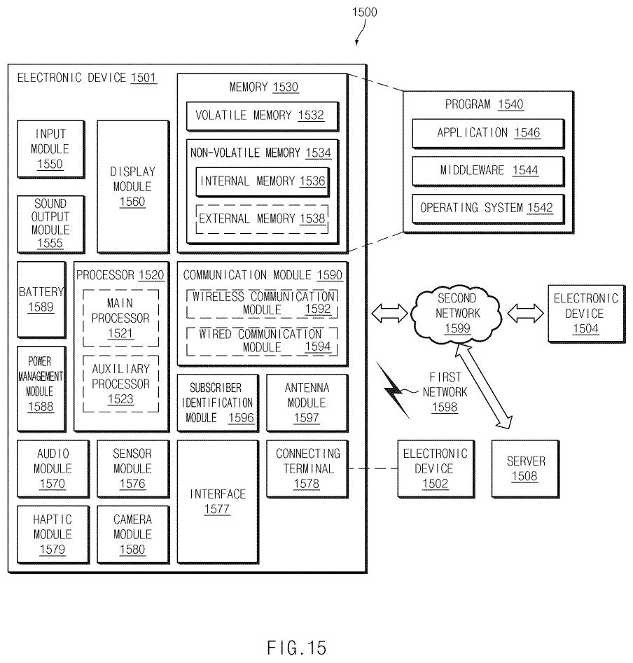

FIG. 15 is a block diagram illustrating an electronic device 1501 in a network environment 1500 according to an embodiment of the disclosure.

Referring to FIG. 15, the electronic device 1501 in the network environment 1500 may communicate with an electronic device 1502 via a first network 1598 (e.g., a short-range wireless communication network), or at least one of an electronic device 1504 or a server 1508 via a second network 1599 (e.g., a long-range wireless communication network). According to an embodiment, the electronic device 1501 may communicate with the electronic device 1504 via the server 1508. According to an embodiment, the electronic device 1501 may include a processor 1520, memory 1530, an input module 1550, a sound output module 1555, a display module 1560, an audio module 1570, a sensor module 1576, an interface 1577, a connecting terminal 1578, a haptic module 1579, a camera module 1580, a power management module 1588, a battery 1589, a communication module 1590, a subscriber identification module (SIM) 1596, or an antenna module 1597. In some embodiments, at least one of the components (e.g., the connecting terminal 1578) may be omitted from the electronic device 1501, or one or more other components may be added in the electronic device 1501. In some embodiments, some of the components (e.g., the sensor module 1576, the camera module 1580, or the antenna module 1597) may be implemented as a single component (e.g., the display module 1560).

The processor 1520 may execute, for example, software (e.g., a program 1540) to control at least one other component (e.g., a hardware or software component) of the electronic device 1501 coupled with the processor 1520, and may perform various data processing or computation. According to one embodiment, as at least part of the data processing or computation, the processor 1520 may store a command or data received from another component (e.g., the sensor module 1576 or the communication module 1590) in volatile memory 1532, process the command or the data stored in the volatile memory 1532, and store resulting data in non-volatile memory 1534. According to an embodiment, the processor 1520 may include a main processor 1521 (e.g., a central processing unit (CPU) or an application processor (AP)), or an auxiliary processor 1523 (e.g., a graphics processing unit (GPU), a neural processing unit (NPU), an image signal processor (ISP), a sensor hub processor, or a communication processor (CP)) that is operable independently from, or in conjunction with, the main processor 1521. For example, when the electronic device 1501 includes the main processor 1521 and the auxiliary processor 1523, the auxiliary processor 1523 may be adapted to consume less power than the main processor 1521, or to be specific to a specified function. The auxiliary processor 1523 may be implemented as separate from, or as part of the main processor 1521.

The auxiliary processor 1523 may control at least some of functions or states related to at least one component (e.g., the display module 1560, the sensor module 1576, or the communication module 1590) among the components of the electronic device 1501, instead of the main processor 1521 while the main processor 1521 is in an inactive (e.g., sleep) state, or together with the main processor 1521 while the main processor 1521 is in an active state (e.g., executing an application). According to an embodiment, the auxiliary processor 1523 (e.g., an image signal processor or a communication processor) may be implemented as part of another component (e.g., the camera module 1580 or the communication module 1590) functionally related to the auxiliary processor 1523. According to an embodiment, the auxiliary processor 1523 (e.g., the neural processing unit) may include a hardware structure specified for artificial intelligence model processing. An artificial intelligence model may be generated by machine learning. Such learning may be performed, e.g., by the electronic device 1501 where the artificial intelligence is performed or via a separate server (e.g., the server 1508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1530 may store various data used by at least one component (e.g., the processor 1520 or the sensor module 1576) of the electronic device 1501. The various data may include, for example, software (e.g., the program 1540) and input data or output data for a command related thererto. The memory 1530 may include the volatile memory 1532 or the non-volatile memory 1534.

The program 1540 may be stored in the memory 1530 as software, and may include, for example, an operating system (OS) 1542, middleware 1544, or an application 1546.

The input module 1550 may receive a command or data to be used by another component (e.g., the processor 1520) of the electronic device 1501, from the outside (e.g., a user) of the electronic device 1501. The input module 1550 may include, for example, a microphone, a mouse, a keyboard, a key (e.g., a button), or a digital pen (e.g., a stylus pen).

The sound output module 1555 may output sound signals to the outside of the electronic device 1501. The sound output module 1555 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1560 may visually provide information to the outside (e.g., a user) of the electronic device 1501. The display module 1560 may include, for example, a display, a hologram device, or a projector and control circuitry to control a corresponding one of the display, hologram device, and projector. According to an embodiment, the display module 1560 may include a touch sensor adapted to detect a touch, or a pressure sensor adapted to measure the intensity of force incurred by the touch.

The audio module 1570 may convert a sound into an electrical signal and vice versa. According to an embodiment, the audio module 1570 may obtain the sound via the input module 1550, or output the sound via the sound output module 1555 or a headphone of an external electronic device (e.g., an electronic device 1502) directly (e.g., wiredly) or wirelessly coupled with the electronic device 1501.

The sensor module 1576 may detect an operational state (e.g., power or temperature) of the electronic device 1501 or an environmental state (e.g., a state of a user) external to the electronic device 1501, and then generate an electrical signal or data value corresponding to the detected state. According to an embodiment, the sensor module 1576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1577 may support one or more specified protocols to be used for the electronic device 1501 to be coupled with the external electronic device (e.g., the electronic device 1502) directly (e.g., wiredly) or wirelessly. According to an embodiment, the interface 1577 may include, for example, a high definition multimedia interface (HDMI), a universal serial bus (USB) interface, a secure digital (SD) card interface, or an audio interface.

A connecting terminal 1578 may include a connector via which the electronic device 1501 may be physically connected with the external electronic device (e.g., the electronic device 1502). According to an embodiment, the connecting terminal 1578 may include, for example, a HDMI connector, a USB connector, a SD card connector, or an audio connector (e.g., a headphone connector).

The haptic module 1579 may convert an electrical signal into a mechanical stimulus (e.g., a vibration or a movement) or electrical stimulus which may be recognized by a user via his tactile sensation or kinesthetic sensation. According to an embodiment, the haptic module 1579 may include, for example, a motor, a piezoelectric element, or an electric stimulator.

The camera module 1580 may capture a still image or moving images. According to an embodiment, the camera module 1580 may include one or more lenses, image sensors, image signal processors, or flashes.

The power management module 1588 may manage power supplied to the electronic device 1501. According to one embodiment, the power management module 1588 may be implemented as at least part of, for example, a power management integrated circuit (PMIC).

The battery 1589 may supply power to at least one component of the electronic device 1501. According to an embodiment, the battery 1589 may include, for example, a primary cell which is not rechargeable, a secondary cell which is rechargeable, or a fuel cell.

The communication module 1590 may support establishing a direct (e.g., wired) communication channel or a wireless communication channel between the electronic device 1501 and the external electronic device (e.g., the electronic device 1502, the electronic device 1504, or the server 1508) and performing communication via the established communication channel. The communication module 1590 may include one or more communication processors that are operable independently from the processor 1520 (e.g., the application processor (AP)) and supports a direct (e.g., wired) communication or a wireless communication. According to an embodiment, the communication module 1590 may include a wireless communication module 1592 (e.g., a cellular communication module, a short-range wireless communication module, or a global navigation satellite system (GNSS) communication module) or a wired communication module 1594 (e.g., a local area network (LAN) communication module or a power line communication (PLC) module). A corresponding one of these communication modules may communicate with the external electronic device via the first network 1598 (e.g., a short-range communication network, such as Bluetooth™, wireless-fidelity (Wi-Fi) direct, or infrared data association (IrDA)) or the second network 1599 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1592 may identify and authenticate the electronic device 1501 in a communication network, such as the first network 1598 or the second network 1599, using subscriber information (e.g., international mobile subscriber identity (IMSI)) stored in the subscriber identification module 1596.

The wireless communication module 1592 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1592 may support a high-frequency band (e.g., the mmWave band) to achieve, e.g., a high data transmission rate. The wireless communication module 1592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1592 may support various requirements specified in the electronic device 1501, an external electronic device (e.g., the electronic device 1504), or a network system (e.g., the second network 1599). According to an embodiment, the wireless communication module 1592 may support a peak data rate (e.g., 20 Gbps or more) for implementing eMBB, loss coverage (e.g., 1564 dB or less) for implementing mMTC, or U-plane latency (e.g., 0.5 ms or less for each of downlink (DL) and uplink (UL), or a round trip of 15 ms or less) for implementing URLLC.

The antenna module 1597 may transmit or receive a signal or power to or from the outside (e.g., the external electronic device) of the electronic device 1501. According to an embodiment, the antenna module 1597 may include an antenna including a radiating element composed of a conductive material or a conductive pattern formed in or on a substrate (e.g., a printed circuit board (PCB)). According to an embodiment, the antenna module 1597 may include a plurality of antennas (e.g., array antennas). In such a case, at least one antenna appropriate for a communication scheme used in the communication network, such as the first network 1598 or the second network 1599, may be selected, for example, by the communication module 1590 (e.g., the wireless communication module 1592) from the plurality of antennas. The signal or the power may then be transmitted or received between the communication module 1590 and the external electronic device via the selected at least one antenna. According to an embodiment, another component (e.g., a radio frequency integrated circuit (RFIC)) other than the radiating element may be additionally formed as part of the antenna module 1597.

According to various embodiments, the antenna module 1597 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1501 and the external electronic device 1504 via the server 1508 coupled with the second network 1599. Each of the electronic devices 1502 or 1504 may be a device of a same type as, or a different type, from the electronic device 1501. According to an embodiment, all or some of operations to be executed at the electronic device 1501 may be executed at one or more of the external electronic devices 1502, 1504, or 1508. For example, if the electronic device 1501 should perform a function or a service automatically, or in response to a request from a user or another device, the electronic device 1501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1501. The electronic device 1501 may provide the outcome, with or without further processing of the outcome, as at least part of a reply to the request. To that end, a cloud computing, distributed computing, mobile edge computing (MEC), or client-server computing technology may be used, for example. The electronic device 1501 may provide ultra low-latency services using, e.g., distributed computing or mobile edge computing. In another embodiment, the external electronic device 1504 may include an internet-of-things (IoT) device. The server 1508 may be an intelligent server using machine learning and/or a neural network. According to an embodiment, the external electronic device 1504 or the server 1508 may be included in the second network 1599. The electronic device 1501 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1540) including one or more instructions that are stored in a storage medium (e.g., internal memory 1536 or external memory 1538) that is readable by a machine (e.g., the electronic device 1501). For example, a processor (e.g., the processor 1520) of the machine (e.g., the electronic device 1501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device providing a sound source edit function, the electronic device comprising:
memory configured to store an original sound source and at least one instruction; and
at least one processor operatively connected to the memory,
wherein the at least one instruction, when executed by the at least one processor individually or collectively, causes the electronic device to:
receive an original sound source including a plurality of sound source elements,
select a test sound source corresponding to the original sound source from among a plurality of test sound sources that are pre-stored, the plurality of test sound sources each being matched to at least one of a plurality of sound source separators according to a performance indicator,
select at least one sound source separator, which corresponds to separation of the test sound source, from among the plurality of sound source separators,
extract the plurality of sound source elements by separating the original sound source by using the selected at least one sound source separator, and
store an edit sound source including the extracted plurality of sound source elements.

2. The electronic device of claim 1, wherein the at least one instruction, when executed by the at least one processor individually or collectively, further causes the electronic device to:
in connection with the selecting of the at least one sound source separator, determine the at least one sound source separator based on at least one of a degree of distortion of the plurality of sound source separators for at least one test sound source among the plurality of test sound sources, a speed at which the plurality of sound source separators perform sound source separation, or a hardware resource usage amount of the plurality of sound source separators.

3. The electronic device of claim 1, wherein the performance indicator includes at least one of a source to distortion ratio (SDR), a sources to artifacts ratio (SAR), a signal to interference ratio (SIR), a signal to noise ratio (SNR), or similarity with a target value.

4. The electronic device of claim 1, wherein the at least one instruction, when executed by the at least one processor individually or collectively, further causes the electronic device to:
when a plurality of sound source separators are selected in the selecting of the at least one sound source separator, extract sound source elements by using each sound source separator in the extracting of the plurality of sound source elements.

5. The electronic device of claim 1,
wherein the at least one instruction, when executed by the at least one processor individually or collectively, further causes the electronic device to:
store metadata related to the edit sound source, and
wherein the metadata includes at least one of a name of a sound source separator applied to sound source separation of the original sound source, a number of sound source elements, a type of the sound source elements, or a name of a sound field effector applied to the sound source elements.

6. The electronic device of claim 1, wherein the at least one instruction, when executed by the at least one processor individually or collectively, further causes the electronic device to:
provide at least one edit sound source list stored,
receive a user input for selecting a specific edit sound source included in the edit sound source list, and
output at least one sound source element included in the selected specific edit sound source.

7. The electronic device of claim 6, wherein the at least one instruction, when executed by the at least one processor individually or collectively, further causes the electronic device to:
receive a user input for adjusting a sound field effect of a specific sound source element or a user input for selecting an application program for adjusting a specific sound field effect,
obtain an original sound source corresponding to the selected specific edit sound source, and select a new sound source separator related to adjusting a sound field effect of the specific sound source element or a new sound source separator corresponding to a type of the selected application program,
perform sound source separation on the original sound source by using the new sound source separator,
generate a new edit sound source by applying the sound field effect to a sound source element, which is selected by a user, from among the sound source-separated sound source elements, and
output the new edit sound source.

8. The electronic device of claim 7, wherein the at least one instruction, when executed by the at least one processor individually or collectively, further causes the electronic device to:
in relation to the selecting of the new sound source separator,
obtain a matching table with a sound source separator that provides a performance indicator of a specified reference value or higher in the applying of a sound field effect to the specific sound source element, and
select the new sound source separator based on the matching table.

9. The electronic device of claim 6, wherein the at least one instruction, when executed by the at least one processor individually or collectively, further causes the electronic device to:
provide a screen interface capable of adjusting at least one of a volume or a sound field effect of the at least one sound source element.

10. The electronic device of claim 9, wherein the at least one instruction, when executed by the at least one processor individually or collectively, further causes the electronic device to:
differently output at least one of an object size, color, or a shape corresponding to the at least one sound source element in response to adjusting the at least one of the volume or the sound field effect of the at least one sound source element.

11. A method of providing a sound source edit function performed by an electronic device, the method comprising:
receiving an original sound source including a plurality of sound source elements;
selecting a test sound source corresponding to the original sound source from among a plurality of test sound sources that are pre-stored, the plurality of test sound sources each being matched to at least one of a plurality of sound source separators according to a performance indicator;
selecting at least one sound source separator, which corresponds to separation of the test sound source, from among the plurality of sound source separators;
extracting the plurality of sound source elements by separating the original sound source by using the selected at least one sound source separator; and
storing an edit sound source including the extracted plurality of sound source elements.

12. The method of claim 11, wherein the selecting of the at least one sound source separator includes:
determining the at least one sound source separator based on at least one of a degree of distortion of the plurality of sound source separators for at least one test sound source among the plurality of test sound sources, a speed at which the plurality of sound source separators perform sound source separation, or a hardware resource usage amount of the plurality of sound source separators.

13. The method of claim 11, wherein the performance indicator includes at least one of a source to distortion ratio (SDR), a sources to artifacts ratio (SAR), a signal to interference ratio (SIR), a signal to noise ratio (SNR), or similarity with a target value.

14. The method of claim 11, further comprising:
when a plurality of sound source separators are selected in the selecting of the at least one sound source separator, extracting sound source elements by using each sound source separator in the extracting of the plurality of sound source elements.

15. The method of claim 11, further comprising:
storing metadata related to the edit sound source,
wherein the metadata includes at least one of a name of a sound source separator applied to sound source separation of the original sound source, a number of sound source elements, a type of the sound source elements, or a name of a sound field effector applied to the sound source elements.

16. The method of claim 11, further comprising:
providing at least one edit sound source list stored;
receiving a user input for selecting a specific edit sound source included in the edit sound source list; and
outputting at least one sound source element included in the selected specific edit sound source.

17. The method of claim 16, further comprising:
receiving a user input for adjusting a sound field effect of a specific sound source element or a user input for selecting an application program for adjusting a specific sound field effect;
obtaining an original sound source corresponding to the selected specific edit sound source;
selecting a new sound source separator related to adjusting a sound field effect of the specific sound source element or a new sound source separator corresponding to a type of the selected application program;
performing sound source separation on the original sound source by using the new sound source separator;
generating a new edit sound source by applying the sound field effect to a sound source element, which is selected by a user, from among the sound source-separated sound source elements; and
outputting the new edit sound source.

18. The method of claim 17, wherein the selecting of the new sound source separator includes:
obtaining a matching table with a sound source separator that provides a performance indicator of a specified reference value or higher in the applying of a sound field effect to the specific sound source element; and
selecting the new sound source separator based on the matching table.

19. The method of claim 16, further comprising:
providing a screen interface capable of adjusting at least one of a volume or a sound field effect of the at least one sound source element.

20. The method of claim 19, further comprising:
differently outputting at least one of an object size, color, or a shape corresponding to the at least one sound source element in response to adjusting the at least one of the volume or the sound field effect of the at least one sound source element.
